(19) United States
(12) Patent Application Publication
(10) Pub. No.: US 2019/0124918 A1
(43) Pub. Date: May 2, 2019

(54) BIOFILM FORMATION INHIBITOR AND BIOFILM FORMATION INHIBITING COMPOSITION

(71) Applicant: KAO CORPORATION, Tokyo (JP)

(72) Inventors: Mitsuru SUGIYAMA, Utsunomiya-shi (JP); Hirofumi TAKIGAWA, Oyama-shi (JP); Kenji SASAKI, Koto-ku (JP); Masashi CHIBA, Wakayama-shi (JP); Akira KUMAGAI, Utsunomiya-shi (JP)

(73) Assignee: KAO CORPORATION, Tokyo (JP)

(21) Appl. No.: 16/306,253

(22) PCT Filed: May 30, 2017
(86) PCT No.: PCT/JP2017/020091

§ 371 Date: Nov. 30, 2018

(30) Foreign Application Priority Data
Jun. 3, 2016 (JP) 2016-111610
Jun. 3, 2016 (JP) 2016-111611
Jun. 3, 2016 (JP) 2016-111613
Jun. 3, 2016 (JP) 2016-111614

(51) Int. Cl. A01N 31/16; A01N 35/06; A01N 25/02

(52) U.S. Cl. CPC A01N 31/16; A01N 25/02; A01N 35/06

(57) ABSTRACT

Provided is a biofilm formation inhibitor causing no damage to pipes and instruments and being safe to humans. A biofilm formation inhibitor comprises at least one quinone compound selected from the group consisting of a hydroquinone substituted by a hydroxyl group or an alkyl group, a p-benzoquinone substituted by a hydroxyl group or an alkyl group and a C1 to C5 alkyl resorcinol, as an active ingredient. A biofilm formation inhibition composition comprises a quinone-based compound and a chelating agent. A method for inhibiting biofilm formation comprising adding a quinone-based compound and a chelating agent in an aqueous liquid. A biofilm formation inhibition composition comprises a quinone-based compound and an organic solvent. A method for inhibiting biofilm formation comprises adding the biofilm formation inhibition composition in an aqueous liquid.

### FIELD OF THE INVENTION

The present invention relates to a biofilm formation inhibitor, a biofilm formation inhibition composition and a method for inhibiting biofilm formation.

### BACKGROUND OF THE INVENTION

A biofilm is a construct formed of colonies of microbial such as bacteria and mold attached to a solid or a liquid surface together with a secretion thereof. A biofilm developed in drainage facilities and water circulation systems in houses or factories and the like causes slime and clogging of pipes and malodor. A biofilm also causes corrosion of sewer pipes and deterioration of facilities. Biofilm formation is a problem to reverse osmosis membrane used in seawater desalination plants and piping facilities of paper factories and the like. Furthermore, a biofilm is a cause of microbial contamination. A biofilm developed in e.g., hot spring facilities could cause infection. In the medical field, a biofilm formed on, e.g., dialysis tubes and medical apparatuses, such as endoscopes and contact lens could become a source of infection. Moreover, a biofilm developed on the skin and in the oral cavity could cause diseases. In the food field, a biofilm formed on foods or kitchen utensils could become a cause of rotten foods and food poisoning.

When microorganisms form a biofilm, the microorganisms become resistant against ordinary cleaning and disinfecting method, and thus, it is not easy to remove the microorganisms. Periodical water exchange and cleaning are necessary to prevent biofilm formation in drainage facilities and water circulation systems; however, such operations increase maintenance cost of the facilities and systems.

The biofilm formed in e.g., water circulation systems comprises gram negative microorganisms belonging to e.g., the genus Pseudomonas such as Pseudomonas aeruginosa, the genus Sphingomonas and the genus Sphingopyxis. Further, microorganisms belonging to the genus Klebsiella, the genus Flavobacterium and Roseomonas genus were found in biofilms in water cooling towers according to the reports (Non Patent Literatures 1 and 2). Conventionally, formation of a biofilm in e.g., drainage facilities and water circulation systems has been prevented by germicides such as chlorine agents and organic nitrogen sulfur agents. However, chlorine agents have problems such as damaging pipes and instruments, and organic nitrogen sulfur agents have problems such as damaging skin. Because of these problems, none of agents can be used at a concentration sufficient to kill microorganisms, and thus, biofilm formation cannot be inhibited for a long term.

Patent Literature 1 discloses that a liquid composition (pH12 or more) comprising an N-alkyl substituted hydroxylamine and an alkali metal hydroxide together with a quinone derivative is used for preventing corrosion of boilers. The quinone compound herein is known as an antimicrobial substance. For example, Patent Literatures 2 and 3 disclose that benzoquinone or hydroquinone has an antimicrobial activity against Staphylococcus, Propionibacterium acnes or propionibacterium. Patent Literature 4 discloses that a benzoquinone or hydroquinone derivative has an antimicrobial activity against Staphylococcus aureus and Propionibacterium acnes. Non Patent Literature 3 discloses that a quinone or hydroquinone substituted at position 2 by an alkyl group or an alkenyl group exhibited an antimicrobial activity against Bacillus subtilis and microorganisms belonging to the genus Micrococcus or the genus Candida. Non Patent Literature 4 discloses that tert-butylhydroquinone and tert-butylbenzoquinone have an antimicrobial activity against Staphylococcus aureus and inhibited formation of a biofilm by this bacterium. In contrast, antimicrobial effects of the aforementioned compounds against gram negative bacteria have been reported in a few number of documents, and the antimicrobial activities reported therein were not high. Non Patent Literature 3 fails to clearly describe the minimum inhibitory concentrations (MIC) to gram negative bacteria; however, Non Patent Literature 4 states that the minimum inhibitory concentration (MIC) of tert-butylhydroquinone to B. coli is 512 ppm.

A resorcinol compound is known as an antimicrobial substance. For example, Patent Literature 4 states that dimethyl- and dibutyl-resorcinols have antimicrobial activities against Staphylococcus aureus and Propionibacterium acnes. Non Patent Literature 5 illustrates 4-isopropylresorcinol as an antimicrobial substance against Mycobacterium tuberculosis. In the meantime, whether these compounds have antimicrobial effects against gram negative bacteria such as E. coli and Pseudomonas has not yet been elucidated. Patent Literature 5 illustrates 4-hexylresorcinol as an antimicrobial substance against Propionibacterium acnes. Non Patent Literature 6 states that 4-hexylresorcinol inhibited growth of bacteria belonging to the genus Pseudomonas.
(Patent Literature 1) JP-A-2015-68631
(Patent Literature 2) International Publication WO2007/096601
(Patent Literature 3) JP-A-2008-535814
(Patent Literature 4) International Publication WO 2006/100496
(Patent Literature 5) International Publication WO 2004/091595
(Non Patent Literature 1) Biofouling 2011, 27 (4)393-402
(Non Patent Literature 2) Biocontrol Science 2013, 18 (4)205-209
(Non Patent Literature 3) J Nat Prod, 1994, 57 (12): 1711-1716
(Non Patent Literature 4) J Antimicrob Chemother, 2013, 68 (6): 1297-1304
(Non Patent Literature 5) Anti-Infective Agents, 2012, 10 (1): 6-14
(Non Patent Literature 6) Microbiology, 2005, 74 (2): 128-135

### SUMMARY OF THE INVENTION

The present invention provides a biofilm formation inhibitor comprising at least one quinone compound selected from the group consisting of a hydroquinone substituted by a hydroxyl group or an alkyl group and a p-benzoquinone substituted by a hydroxyl group or an alkyl group, as an active ingredient.

The present invention also provides a method for inhibiting biofilm formation, comprising adding at least one quinone compound selected from the group consisting of a hydroquinone substituted by a hydroxyl group or an alkyl group and a p-benzoquinone substituted by a hydroxyl group or an alkyl group, in target water.

The present invention further provides a biofilm formation inhibitor comprising a C1 to C5 alkyl resorcinol, as an active ingredient.

The present invention also provides a method for inhibiting biofilm formation, comprising adding a C1 to C5 alkyl resorcinol in target water.

The present invention further provides a biofilm formation inhibition composition comprising a quinone-based compound and a chelating agent.

The present invention also provides a method for inhibiting biofilm formation, comprising adding a quinone-based compound and a chelating agent in an aqueous liquid.

The present invention further provides a biofilm formation inhibition composition comprising a quinone-based compound and an organic solvent.

The present invention also provides a method for inhibiting biofilm formation, comprising adding the biofilm formation inhibition composition in an aqueous liquid.

### BRIEF DESCRIPTION OF THE DRAWINGS

FIG. 1 shows biofilm formation inhibition by test compounds. A: Amount of growth (OD600), B: Amount of the biofilm formed (OD570). Abscissa: 1) BtOH control; 2) 2-methylhydroquinone; 3) p-toluquinone; 4) sodium hypochlorite. Bar charts of each of the samples show data values at test-compound concentrations of 7, 20, 33, 67, 200 and 333 ppm in the order from the left.

FIG. 2 shows biofilm formation inhibition by test compounds a to k. A: Amount of growth (OD600), B: Amount of the biofilm formed (OD570). Bar charts of each of the samples show data values at volumes of a compound solution added of 1, 2, 4, 6, 7 and 8 μL in the order from the left.

FIG. 3 shows biofilm formation inhibition by test compounds 1 to 7. A: Amount of growth (OD600), B: Amount of the biofilm formed (OD570). Bar charts of each of the samples show data values at volumes of a compound solution added of 1, 2, 4, 6, 7 and 8 μL in the order from the left.

FIG. 4 shows biofilm formation inhibition by p-toluquinone in an aqueous system model. (a) Solvent control; (b) p-Toluquinone, n=2.

FIG. 5 shows biofilm formation inhibition by 4-butylresorcinol in an aqueous system model. (a) Solvent control; (b) 4-Butylresorcinol, n=2.

### DETAILED DESCRIPTION OF THE INVENTION

### 1. Biofilm Formation Inhibitor

The present invention provides a biofilm formation inhibitor which can effectively inhibit formation of a biofilm, causes no damage to pipes and instruments and is safe to humans.

As a result of intensive studies, the present inventors found that specific quinone compound and resorcinol compound can effectively inhibit formation of a biofilm even if these compounds are used at a low concentration at which growth of a microorganism is not inhibited.

The present invention provides a biofilm formation inhibitor comprising at least one quinone compound selected from the group consisting of a hydroquinone substituted by a hydroxyl group or an alkyl group and a p-benzoquinone substituted by a hydroxyl group or an alkyl group, as an active ingredient. The present invention also provides a biofilm formation inhibitor comprising a C1 to C5 alkyl resorcinol, as an active ingredient. The present invention provides a method for inhibiting biofilm formation, comprising adding the quinone compound or the C1 to C5 alkyl resorcinol in target water.

The biofilm formation inhibitor of the present invention can inhibit formation of a biofilm not relying on a germicidal or antimicrobial effect. Thus, according to the present invention, biofilm formation can be inhibited more safely to humans. According to the present invention, unlike the case of using a germicidal or antimicrobial agent, formation of a biofilm can be effectively inhibited for a long term, because acquisition of resistance by a microbe can be prevented to avoid a reduction in effectiveness. In addition, the biofilm formation inhibitor of the present invention is more economic, since it rarely causes damage to pipes and instruments compared to conventional germicides.

The biofilm formation inhibitor of the present invention is used for inhibiting biofilm formation in various environments including those of households or plant facilities. Preferably, the biofilm formation inhibitor of the present invention is used for inhibiting biofilm formation in facilities, which function by supplying water or storing water, such as pipes in which water flows, tanks and pools for storing water, water circulation systems and instruments attached thereto. The biofilm formation inhibitor of the present invention is suitably applied in a facility at least a part of which reaches a temperature readily for forming a biofilm (for example, 20° C. or more and more preferably 25° C. or more) among the facilities described above Examples of the facility to which the biofilm formation inhibitor of the present invention is suitably applied include plant-facility and building cooling systems using water cooling towers, industrial-use cooling pools, industrial-use water supply routes, water storage tanks or drainage paths, hot water supply heating systems, wastewater treatment facilities, reverse osmosis membrane used in seawater desalination plants and piping facilities of paper factories.

In the specification, “target water” refers to water to which the biofilm formation inhibitor of the present invention is to be applied. Preferably, the “target water” refers to water which is supplied to or stored in the aforementioned facilities that function by supplying or storing water. Examples thereof include water in plant facility and building cooling systems using a water cooling tower, water in industrial-use cooling pools, water in industrial-use water supply routes, water storage tanks or drainage paths, hot water used in hot water supply heating systems, drainage water from wastewater treatment facilities, water passing through reverse osmosis membrane used in seawater desalination plants and water in piping facility of paper factories. The biofilm formation inhibitor of the present invention is added in the target water.

In the biofilm developed in the aforementioned facilities, gram negative microorganisms belonging to e.g., the genus Pseudomonas such as Pseudomonas aeruginosa, the genus Sphingomonas and the genus Sphingopyxis are comprised. Further, gram negative microorganisms belonging to the genus Klebsiella, the genus Flavobacterium and Roseomonas genus are reported as microorganisms present in biofilms in water cooling towers (Non Patent Literatures 1 and 2).

### (1-1. Quinone Compound)

In an embodiment, the biofilm formation inhibitor of the present invention uses at least one quinone compound selected from the group consisting of a hydroquinone substituted by a hydroxyl group or an alkyl group and a p-benzoquinone substituted by a hydroxyl group or an alkyl group, as an active ingredient.

As the hydroquinone and the p-benzoquinone to be used in the present invention as an active ingredient, compounds represented by the following formula (I) and formula (II), respectively, are mentioned.

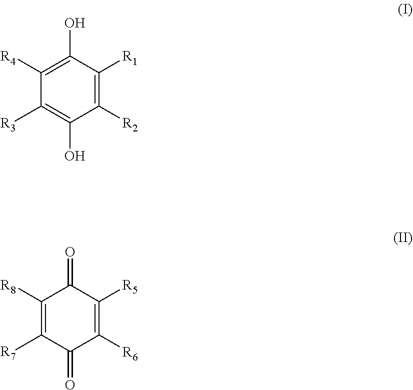

In the formula (I), R₁ represents a hydroxyl group or a linear or branched alkyl group having from 1 to 4 carbon atoms; and R₂, R₃, and R₄ each independently represent hydrogen or a methyl group. In the formula (II), R₅ represents a hydroxyl group or a linear or branched alkyl group having from 1 to 4 carbon atoms; and R₆, R₇ and R₈ each independently represent hydrogen or a methyl group.

In a preferred embodiment, R₁ represents a hydroxyl group or a linear or branched alkyl group having from 1 to 4 carbon atoms; and R₂, R₃ and R₄ all represent hydrogen. In another preferred embodiment, R₁ represents a methyl group; R₃ represents hydrogen; and R₂ and R₄ represent either a methyl group or hydrogen or both represent a methyl group. In another preferred embodiment. R₁, R₂, R₃ and R₄ all represent a methyl group.

In another preferred embodiment, R₅ represents a linear or branched alkyl group having from 1 to 4 carbon atoms; and R₆, R₇ and R₈ all represent hydrogen.

The quinone compound to be used in the present invention as an active ingredient may be any one or any combination (two or more) of the compounds represented by the above formulas (I) and (II).

Preferred examples of the quinone compound to be used in the present invention as an active ingredient include, p-toluquinone, 2-methylhydroquinone, ethylquinol, 2-butylhydroquinone, tert-butylhydroquinone, 2,6-dimethylhydroquinone, 2,3-dimethylhydroquinone, 2,3,5-trimethylhydroquinone, tetramethylhydroquinone, hydroxyhydroquinone, 3,5-dimethylbenzoquinone and tert-butylbenzoquinone. In the present invention, these can be used singly or in any combination (two or more).

### (1-2. Alkyl Resorcinol)

In another embodiment, the biofilm formation inhibitor of the present invention uses a C1 to C5 alkyl resorcinol as an active ingredient.

As the C1 to C5 alkyl resorcinol to be used in the present invention as an active ingredient, a compound represented by the following formula (III) is mentioned.

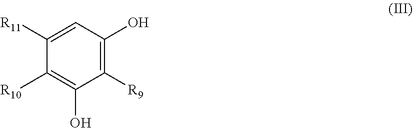

In the formula (III), R₉, R₁₀ and R₁₁ each independently represent hydrogen or a linear or branched alkyl group having from 1 to 5 carbon atoms; provided that R₉, R₁₀ and R₁₁ do not simultaneously represent hydrogen.

In a preferred embodiment, any one of R₉, R₁₀ and R₁₁ represents a linear or branched alkyl group having from 1 to 5 carbon atoms and the others both represent hydrogen. More preferably, any one of R₉, R₁₀ and R₁₁ represents a linear or branched alkyl group having from 1 to 4 carbon atoms and the others both represent hydrogen.

In another preferred embodiment, any two of R₉, R₁₀ and R₁₁ represent a linear alkyl group having from 1 to 5 carbon atoms and the other represents hydrogen. More preferably, any two of R₉, R₁₀ and R₁₁ represent a linear alkyl group having from 1 to 4 carbon atoms and the other represents hydrogen.

The C1 to C5 alkyl resorcinol to be used in the present invention as an active ingredient may be any one of the compounds represented by the above formula (III) or any combination of two or more of them.

Preferred examples of the C1 to C5 alkyl resorcinol to be used in the present invention as an active ingredient include 4-butylresorcinol (rucinol), 5-methylresorcinol, 5-pentylresorcinol, 2-propylresorcinol, 2,5-dimethylresorcinol, 2-methylresorcinol and 4-isopropylresorcinol. In the present invention, these can be used singly or in any combination (two or more).

The active ingredient of the biofilm formation inhibitor of the present invention may be at least one compound selected from the group consisting of a hydroquinone substituted by a hydroxyl group or an alkyl group, p-benzoquinone substituted by a hydroxyl group or an alkyl group and a C1 to C5 alkyl resorcinol described above.

### (1-3. Other Components)

The biofilm formation inhibitor of the present invention may comprise other components other than the quinone compounds or C1 to C5 alkyl resorcinol. Examples of the other components include a solvent for the quinone compounds or C1 to C5 alkyl resorcinol; a washing agent or a substance for preventing deterioration of instruments and facilities to which the biofilm formation inhibitor of the present invention is to be applied; and an antimicrobial or germicide. However, the types and concentrations of the other components are not particularly limited as long as they do not inhibit the biofilm formation inhibitory effect of the quinone compounds or C1 to C5 alkyl resorcinol.

Preferably, the biofilm formation inhibitor of the present invention does not comprise a chelating agent. The chelating agents include such as a carboxylic acid-based, a phosphoric acid-based or a phosphonic acid-based chelating agent. Examples of the carboxylic acid-based chelating agent include a polyvalent carboxylic acid, a hydroxycarboxylic acid, an aminocarboxylic acid, a phosphonocarboxylic acid and salts thereof. Examples of the polyvalent carboxylic acid include citric acid, succinic acid, malic acid, fumaric acid, tartaric acid, malonic acid and maleic acid. Examples of the hydroxycarboxylic acid include aliphatic hydroxycarboxylic acids such as citric acid and malic acid. Examples of the aminocarboxylic acid include ethylenediaminetetraacetic acid (EDTA), nitrilotriacetic acid (NTA), iminodiacetic acid, diethylenetriaminepentaacetic acid (DPTA), N-hydroxyethyl-ethylenediaminetriacetic acid (HEDTA), methylglycinediacetic acid (MGDA), aspartic acid diacetic acid (ASDA) and glutamic acid diacetic acid (GLDA). Examples of the phosphonocarboxylic acid include 2-phosphonobutane-1,2,4-tricarboxylic acid. Examples of the phosphoric acid-based chelating agent include such as tripolyphosphoric acid and a salt thereof. Examples of the phosphonic acid-based chelating agent include hydroxyphosphonic acids such as 1-hydroxyethane-1,1-diphosphonic acid (HEDP), aminophosphonic acids such as aminotrimethylenephosphonic acid (ATMP), and salts of these. Examples of the salts include salts of alkali metals such as sodium and potassium, ammonium salts and amine salts.

Further preferably, the biofilm formation inhibitor of the present invention does not comprise an organic solvent. As the organic solvent, an organic solvent having a C log P value of from −3 to 4, from −3 to 3.5, from −3 to 3, from −2.5 to 4, from −2.5 to 3.5, from −2.5 to 3, from −2 to 4, from −2 to 3.5 or from −2 to 3 is mentioned. C log P value used herein refers to a calculated value representing an octanol/water partition coefficient (log P) in accordance with EPIWEB4.1 (US EPA). As a specific example of the organic solvent, an alcohol-based organic solvent or an ether-based organic solvent is mentioned. As more specific example thereof, an aliphatic alcohol-based organic solvent, an aliphatic ether-based organic solvent and a glycol-based organic solvent are mentioned. As an example of the glycol-based organic solvent, a mono or polyalkylene glycol monoalkyl ether is mentioned. Specific examples thereof include ethylene glycol (2-ethylhexyl) ether, 1-phenoxy-2-propanol, 2-phenoxyethanol, 1-butoxy-2-propanol, ethylene glycol monobutyl ether, 2-isobutoxyethanol, 2-(2-n-butoxyethoxy) ethanol, propylene glycol, 2-(2-isobutoxyethoxy) ethanol, triethylene glycol monobutyl ether, diacetone alcohol, 2-ethoxyethanol, 1-methoxy-2-p-propanol, dipropylene glycol, 2-(2-ethoxyethoxy) ethanol, 2-methoxyethanol, diethylene glycol monomethyl ether, diethylene glycol, triethylene glycol monomethyl ether and diethylene glycol monomethyl ether.

### (1-4. Use of Biofilm Formation Inhibitor)

Conventionally, a formation of biofilm has been prevented by killing causative microorganisms of a biofilm by use of a germicide. In contrast, in the present invention, as shown in Examples (described later), formation of a biofilm is inhibited not relying on inhibition of growth of causative microorganisms of a biofilm by use of the quinone compounds or C1 to C5 alkyl resorcinol. In this respect, the method of the present invention differs from conventional methods inhibiting biofilm formation by germicidal or antimicrobial effect. Accordingly, a preferred aspect of the biofilm formation inhibitor of the present invention is a non-antimicrobial biofilm formation inhibitor. The “non-antimicrobial biofilm formation inhibition” herein refers to an effect to inhibit formation of a biofilm not relying on antimicrobial (or germicidal) effect.

Accordingly, the biofilm formation inhibitor of the present invention can employ the quinone compound or C1 to C5 alkyl resorcinol, as an active ingredient, at a low concentration at which no antimicrobial activity against causative microorganisms of a biofilm is exerted.

In a preferred embodiment, the biofilm formation inhibitor of the present invention can be used in an amount with which the concentration of the quinone compound in target water becomes at 270 ppm (mass ppm, the same will apply hereinafter in the specification) or less. In more preferred embodiment, when the quinone compound is at least one selected from the group consisting of p-toluquinone, 2-methylhydroquinone, ethylquinol, 2-butylhydroquinone, tert-butylhydroquinone, hydroxyhydroquinone, 3,5-dimethylbenzoquinone and tert-butylbenzoquinone, the biofilm formation inhibitor of the present invention is used in an amount with which the concentration of the quinone compound in target water becomes 270 ppm or less and preferably 200 ppm or less. In another more preferred embodiment, when the quinone compound is at least one selected from the group consisting of 2,6-dimethylhydroquinone, 2,3-dimethylhydroquinone and 2,3,5-trimethylhydroquinone, the biofilm formation inhibitor of the present invention is used in an amount with which the concentration of the quinone compound in target water becomes 60 ppm or less and preferably 30 ppm or less.

When the quinone compound is p-toluquinone, the concentration thereof in target water is preferably 5 ppm or more, more preferably 7 ppm or more, further preferably 15 ppm or more and still preferably 20 ppm or more; and preferably less than 200 ppm, more preferably 150 ppm or less, further preferably 140 ppm or less and still preferably 100 ppm or less; or preferably 5 ppm or more and less than 200 ppm, from 5 to 150 ppm, from 5 to 140 ppm, from 5 to 100 ppm, 7 ppm or more and less than 200 ppm, from 7 to 150 ppm, from 7 to 140 ppm, from 7 to 100 ppm, from 15 ppm or more and less than 200 ppm, from 15 to 150 ppm, from 15 to 140 ppm, from 15 to 100 ppm, 20 ppm or more and less than 200 ppm, from 20 to 150 ppm and from 20 to 140 ppm or from 20 to 100 ppm.

When the quinone compound is 2-methylhydroquinone, the concentration thereof in target water is preferably 10 ppm or more, more preferably 15 ppm or more, further preferably 30 ppm or more and still preferably 40 ppm or more; and preferably less than 200 ppm, more preferably 150 ppm or less, further preferably 130 ppm or less and still preferably 100 ppm or less; or preferably, 10 ppm or more and less than 200 ppm, from 10 to 150 ppm, from 10 to 130 ppm, from 10 to 100 ppm, 15 ppm or more and less than 200 ppm, from 15 to 150 ppm, from 15 to 130 ppm, from 15 to 100 ppm, 30 ppm or more and less than 200 ppm, from 30 to 150 ppm, from 30 to 130 ppm, from 30 to 100 ppm, 40 ppm or more and less than 200 ppm, from 40 to 130 ppm, from 40 to 140 ppm or from 40 to 100 ppm.

When the quinone compound is ethylquinol, the concentration thereof in target water is preferably 7 ppm or more, more preferably 20 ppm or more and further preferably 30 ppm or more; and preferably 200 ppm or less, more preferably 150 ppm or less, further preferably 120 ppm or less and still preferably 80 ppm or less; or preferably from 7 to 200 ppm, from 7 to 150 ppm, from 7 to 120 ppm, from 7 to 80 ppm, from 20 to 200 ppm, from 20 to 150 ppm, from 20 to 120 ppm, from 20 to 80 ppm, from 30 to 200 ppm, from 30 to 150 ppm, from 30 to 120 ppm, or from 30 to 80 ppm.

When the quinone compound is 2-butylhydroquinone, the concentration thereof in target water is preferably 7 ppm or more, more preferably 20 ppm or more and further preferably 30 ppm or more; and preferably 270 ppm or less, more preferably 200 ppm or less, further preferably 180 ppm or less and still preferably 150 ppm or less; or preferably from 7 to 270 ppm, from 7 to 200 ppm, from 7 to 180 ppm, from 7 to 150 ppm, from 20 to 270 ppm, from 20 to 200 ppm, from 20 to 180 ppm, from 20 to 150 ppm, from 30 to 270 ppm, from 30 to 200 ppm, from 30 to 180 ppm, or from 30 to 150 ppm.

When the quinone compound is tert-butylhydroquinone, the concentration thereof in target water is preferably 7 ppm or more, more preferably 20 ppm or more and further preferably 30 ppm or more; and preferably 270 ppm or less, more preferably 200 ppm or less, further preferably 180 ppm or less and still preferably 150 ppm or less; or preferably from 7 to 270 ppm, from 7 to 200 ppm, from 7 to 180 ppm, from 7 to 150 ppm, from 20 to 270 ppm, from 20 to 200 ppm, from 20 to 180 ppm, from 20 to 150 ppm, from 30 to 270 ppm, from 30 to 200 ppm, from 30 to 180 ppm, or from 30 to 150 ppm.

When the quinone compound is 2,6-dimethylhydroquinone, the concentration thereof in target water is preferably 2 ppm or more, more preferably 5 ppm or more and further preferably 10 ppm or more; and preferably 60 ppm or less, more preferably 40 ppm or less and further preferably 35 ppm or less; or preferably from 2 to 60 ppm, from 2 to 40 ppm, from 2 to 35 ppm, from 5 to 60 ppm, from 5 to 40 ppm, from 5 to 35 ppm, from 10 to 60 ppm, from 10 to 40 ppm or from 10 to 35 ppm.

When the quinone compound is 2,3-dimethylhydroquinone, the concentration thereof in target water is preferably 10 ppm or more, more preferably 20 ppm or more, further preferably 30 ppm or more and still preferably 35 ppm or more; and preferably 60 ppm or less, more preferably 40 ppm or less and further preferably 35 ppm or less; or preferably from 10 to 60 ppm, from 10 to 40 ppm, from 10 to 35 ppm, from 20 to 60 ppm, from 20 to 40 ppm, from 20 to 35 ppm, from 30 to 60 ppm, from 30 to 40 ppm, from 30 to 35 ppm, from 35 to 60 ppm or from 35 to 40 ppm.

When the quinone compound is 2,3,5-trimethylhydroquinone, the concentration thereof in target water is preferably 2 ppm or more, more preferably 5 ppm or more and further preferably 10 ppm or more; and preferably 30 ppm or less and more preferably 20 ppm or less; or preferably from 2 to 30 ppm, from 2 to 20 ppm, from 5 to 30 ppm, from 5 to 20 ppm, from 10 to 30 ppm, or from 10 to 20 ppm.

When the quinone compound is hydroxyhydroquinone, the concentration thereof in target water is preferably 10 ppm or more, more preferably 20 ppm or more, further preferably 30 ppm or more and still preferably 35 ppm or more; and preferably 200 ppm or less, more preferably 150 ppm or less and further preferably 130 ppm or less; or preferably from 10 to 200 ppm, from 10 to 150 ppm, from 10 to 130 ppm, from 20 to 200 ppm, from 20 to 150 ppm, from 20 to 130 ppm, from 30 to 200 ppm, from 30 to 150 ppm, from 30 to 130 ppm, from 35 to 200 ppm, from 35 to 150 ppm or from 35 to 130 ppm.

When the quinone compound is 3,5-dimethylbenzoquinone, the concentration thereof in target water is preferably 6 ppm or more, more preferably 15 ppm or more and further preferably 18 ppm or more; and preferably 60 ppm or less, more preferably 40 ppm or less and further preferably 35 ppm or less; or preferably from 6 to 60 ppm, from 6 to 40 ppm, from 6 to 35 ppm, from 15 to 60 ppm, from 15 to 40 ppm, from 15 to 35 ppm, from 18 to 60 ppm, from 18 to 40 ppm or from 18 to 35 ppm.

When the quinone compound is tert-butylbenzoquinone, the concentration thereof in target water is preferably 50 ppm or more, more preferably 150 ppm or more, further preferably 160 ppm or more; and preferably 270 ppm or less, more preferably 200 ppm or less and further preferably 180 ppm or less; or preferably from 50 to 270 ppm, from 50 to 200 ppm, from 50 to 180 ppm, from 150 to 270 ppm, from 150 to 200 ppm, from 150 to 180 ppm, from 160 to 270 ppm, from 160 to 200 ppm or from 160 to 180 ppm.

In another preferred embodiment, the biofilm formation inhibitor of the present invention is used in an amount with which the concentration of the C1 to C5 alkyl resorcinol in target water becomes 1400 ppm or less (mass ppm, the same will apply hereinafter in the specification). In more preferred embodiment, when the C1 to C5 alkyl resorcinol is 4-butylresorcinol, the biofilm formation inhibitor of the present invention is used in an amount with which the concentration of the alkyl resorcinol in target water becomes 200 ppm or less. In another more preferred embodiment, when the C1 to C5 alkyl resorcinol is at least one selected from the group consisting of 5-methylresorcinol, 5-pentylresorcinol, 2-propylresorcinol, 2,5-dimethylresorcinol, 2-methylresorcinol and 4-isopropylresorcinol, the biofilm formation inhibitor of the present invention is used in an amount with which the concentration of the alkyl resorcinol in target water becomes 1400 ppm or less and further preferably 1000 ppm or less.

When the C1 to C5 alkyl resorcinol is 4-butylresorcinol, the concentration thereof in target water is preferably 15 ppm or more, more preferably 40 ppm or more and further preferably 50 ppm or more; and preferably 200 ppm or less, more preferably 145 ppm or less and further preferably 130 ppm or less; or preferably from 15 to 200 ppm, from 15 to 145 ppm, from 15 to 130 ppm, from 40 to 200 ppm, from 40 to 145 ppm, from 40 to 130 ppm, from 50 to 200 ppm, from 50 to 145 ppm, or from 50 to 130 ppm.

When the C1 to C5 alkyl resorcinol is 5-methylresorcinol, the concentration thereof in target water is preferably 165 ppm or more, more preferably 450 ppm or more and further preferably 500 ppm or more; and preferably 1000 ppm or less, more preferably 700 ppm or less and further preferably 600 ppm or less; or preferably from 165 to 1000 ppm, from 165 to 700 ppm, from 165 to 600 ppm, from 450 to 1000 ppm, from 450 to 700 ppm, from 450 to 600 ppm, from 500 to 1000 ppm, from 500 to 700 ppm, or from 500 to 600 ppm.

When the C1 to C5 alkyl resorcinol is 5-pentylresorcinol, the concentration thereof in target water is preferably 160 ppm or more, more preferably 400 ppm or more and further preferably 500 ppm or more; and preferably 1400 ppm or less, more preferably 1000 ppm or less and further preferably 950 ppm or less; or preferably from 160 to 1400 ppm, from 160 to 1000 ppm, from 160 to 950 ppm, from 400 to 1400 ppm, from 400 to 1000 ppm, from 400 to 950 ppm, from 500 to 1400 ppm, from 500 to 1000 ppm, or from 500 to 950 ppm.

When the C1 to C5 alkyl resorcinol is 2-propylresorcinol, the concentration thereof in target water is preferably 200 ppm or more, more preferably 600 ppm or more and further preferably 700 ppm or more; and preferably 1200 ppm or less, more preferably 1000 ppm or less and further preferably 850 ppm or less; or preferably from 200 to 1200 ppm, from 200 to 1000 ppm, from 200 to 850 ppm, from 600 to 1200 ppm, from 600 to 1000 ppm, from 600 to 850 ppm, from 700 to 1200 ppm, from 700 to 1000 ppm, or from 700 to 850 ppm.

When the C1 to C5 alkyl resorcinol is 2,5-dimethylresorcinol, the concentration thereof in target water is preferably 180 ppm or more, more preferably 550 ppm or more and further preferably 650 ppm or more; and preferably 1100 ppm or less, more preferably 800 ppm or less and further preferably 740 ppm or less; or preferably from 180 to 1100 ppm, from 180 to 800 ppm, from 180 to 740 ppm, from 550 to 1100 ppm, from 550 to 800 ppm, from 550 to 740 ppm, from 650 to 1100 ppm, from 650 to 800 ppm, or from 650 to 740 ppm.

When the C1 to C5 alkyl resorcinol is 2-methylresorcinol, the concentration thereof in target water is preferably 165 ppm or more, more preferably 450 ppm or more and further preferably 500 ppm or more; and preferably 1000 ppm or less, more preferably 700 ppm or less and further preferably 650 ppm or less; or preferably from 165 to 1000 ppm, from 165 to 700 ppm, from 165 to 650 ppm, from 450 to 1000 ppm, from 450 to 700 ppm, from 450 to 650 ppm, from 500 to 1000 ppm, from 500 to 700 ppm, or from 500 to 650 ppm.

When the C1 to C5 alkyl resorcinol is 4-isopropylresorcinol, the concentration thereof in target water is preferably 200 ppm or more, more preferably 500 ppm or more and further preferably 600 ppm or more; and preferably 1100 ppm or less, more preferably 700 ppm or less and further preferably 650 ppm or less; or preferably from 200 to 1100 ppm, from 200 to 700 ppm, from 200 to 650 ppm, from 500 to 1100 ppm, from 500 to 700 ppm, from 500 to 650 ppm, from 600 to 1100 ppm, from 600 to 700 ppm, or from 600 to 650 ppm.

In consideration of biological safety and economic efficiency, the biofilm formation inhibitor of the present invention is preferably used in an amount with which the concentration of the quinone compound or C1 to C5 alkyl resorcinol in target water becomes less than the minimum inhibitory concentration (MIC) of a main causative microorganism (for example, Pseudomonas) of a biofilm. Alternatively, the biofilm formation inhibitor of the present invention is preferably used in an amount with which the concentration of the quinone compound or C1 to C5 alkyl resorcinol in target water provides a growth inhibition rate of a main causative microorganism (for example, Pseudomonas) of 20% or less. The growth inhibition rate of a microorganism herein refers to a reduction rate (%) of the amount of growth of a microorganism in target water comprising the biofilm formation inhibitor when the amount of growth of the microorganism in target water comprising no biofilm formation inhibitor is regarded as 100%, and represented by

[1−(the amount of growth of a microorganism in an agent comprising group/the amount of growth of a microorganism in a non-agent comprising group)}×100].

The amount of growth of a microorganism can be measured, for example, based on OD600.

When the biofilm formation is inhibited according to the present invention, the quinone compound or C1 to C5 alkyl resorcinol is preferably added in target water such that the concentration thereof in target water falls within the aforementioned predetermined range. In the present invention, it is not necessary to always maintain the concentration of the quinone compound or C1 to C5 alkyl resorcinol in target water in the aforementioned predetermined range. The concentration of the quinone compound or C1 to C5 alkyl resorcinol in the target water may be, as necessary or periodically, controlled to fall within the aforementioned predetermined range and maintained for a predetermined time. In view of biofilm formation inhibitory effect, the concentration of the quinone compound or C1 to C5 alkyl resorcinol in the target water is preferably maintained within the aforementioned predetermined range for 24 hours or more. The amount and frequency of addition of the quinone compound or C1 to C5 alkyl resorcinol in target water can be appropriately set in accordance with e.g., the total volume of target water and volume to be exchanged, frequency of use, internal temperature, the extent of contamination or maintenance schedule of the instrument or facility comprising target water.

### 2. Biofilm Formation Inhibition Composition and Biofilm Formation Inhibition Method

The present invention provides a biofilm formation inhibition composition and biofilm formation inhibition method for efficiently inhibiting biofilm formation in an aqueous system.

The present inventors found that even if a quinone-based compound and a chelating agent are used at low concentrations at which growth of a microorganism is not inhibited, formation of a biofilm can be effectively inhibited. The present inventors further found that a composition comprising a quinone-based compound and an organic solvent is used at a concentration at which handling of the quinone-based compound is improved but growth of a microorganism is not inhibited, formation of a biofilm is effectively prevented.

The present invention provides a biofilm formation inhibition composition comprising a quinone-based compound and a chelating agent. The present invention also provides a method for inhibiting biofilm formation using a quinone-based compound and a chelating agent. The present invention further provides a biofilm formation inhibition composition comprising a quinone-based compound and an organic solvent and a method for inhibiting biofilm formation using it.

According to the biofilm formation inhibition composition of the present invention and the method for inhibiting biofilm formation of the present invention, formation of a biofilm can be effectively inhibited even if the composition is used at a low concentration at which growth of a microorganism is not inhibited. The biofilm formation inhibition composition of the present invention comprising a quinone-based compound and an organic solvent is also excellent in handling.

In the specification, “aqueous system” refers to a system having e.g., a pipe, a tank or a pool and functioning by supplying or storing an aqueous liquid in the system. Examples thereof include plant-facility and building cooling systems using water cooling towers, industrial-use cooling pools, industrial-use water supply routes, water storage tanks or drainage paths, wastewater treatment facilities, hot water supply heating systems, tanks, pools and filtration facilities. Preferably, the aqueous system to which the biofilm formation inhibition composition of the present invention is to be applied is an aqueous system at least a part of which sometimes reaches a temperature at which biofilm is easily formed, for example, preferably 5° C. or more, more preferably 10° C. or more, further preferably 15° C. or more, further preferably 20° C. or more and further preferably 25° C. or more.

In the specification, the “aqueous liquid” may be just water or a liquid comprising water and other components (compounds). Examples of the other components (compounds) include an organic solvent, a salt, an antimicrobial/antifungal agent, an antiseptic/antifungal agent, an antibiotic substance, a penetration enhancer, a surfactant, a deodorant and a fragrance. The water content in the aqueous liquid is preferably 90% by mass or more, more preferably 95% by mass or more, further preferably 98% by mass or more and further preferably 99% by mass or more; and preferably 100% by mass or less.

The “aqueous liquid” is preferably an aqueous liquid industrially used and more preferably an aqueous liquid used in the aforementioned aqueous systems, such as aqueous mediums used in plant-facility and building cooling systems using water cooling towers; aqueous mediums used in hot water supply heating systems, drainage water from wastewater treatment facilities or aqueous liquids in the industrial use cooling pools, industrial-use water supply routes, water storage tanks or drainage paths, or in tanks and pools.

Preferably, the biofilm formation inhibition composition of the present invention is used for inhibiting biofilm formation in aqueous liquids flowing through the above aqueous systems or storing in the systems, and in facilities and instruments of the aqueous systems in contact with the aqueous liquids. More preferably, the biofilm formation inhibition composition of the present invention is used for inhibiting biofilm formation in facilities, instruments of water cooling towers or in aqueous liquids (for example, cooling water in water cooling towers) contained in them.

In the biofilm developed in the aforementioned aqueous systems, gram negative microorganisms belonging to e.g., the genus Pseudomonas such as Pseudomonas aeruginosa, the genus Sphingomonas and the genus Sphingopyxis are contained. Further, gram negative microorganisms belonging to the genus Klebsiella, the genus Flavobacterium and Roseomonas genus are reported as microorganisms present in biofilms in water cooling towers (Non Patent Literatures 1 and 2).

Conventionally, formation of a biofilm has been prevented by killing causative microorganisms of a biofilm by using a germicide. In contrast, in the present invention, biofilm formation may be inhibited by killing causative microorganisms of a biofilm by use of a quinone-based compound; however, biofilm formation can be inhibited without inhibiting growth of causative microorganisms of biofilm, by using a quinone-based compound at a low concentration. A method for inhibiting biofilm formation without inhibiting growth of the causative microorganisms is more preferred in terms of suppressing the generation of resistant bacteria, and thereby reducing environmental burden due to the use of a high-concentration of a chemical agent.

### (2-1. Combined Use of a Quinone-Based Compound and a Chelating Agent)

In an embodiment, the biofilm formation inhibition composition of the present invention comprises a quinone-based compound and a chelating agent. The quinone-based compound and chelating agent mutually work in concert as an active ingredient for inhibiting biofilm formation.

### (2-1-1. Quinone-Based Compound)

The quinone-based compound used in the biofilm formation inhibition composition of the present invention comprising a quinone-based compound and a chelating agent is a compound having a single benzene ring having two or three ketone groups and the benzene ring is optionally substituted by an alkyl group. The alkyl group substituting the benzene ring is preferably a linear or branched alkyl group having 1 or more and 12 or less carbon atoms, more preferably 1 or more and 8 or less carbon atoms, further preferably 1 or more and 6 or less carbon atoms and still preferably 1 or more and 3 or less carbon atoms. Examples thereof include a methyl group, an ethyl group, a propyl group, an isopropyl group, a butyl group, a t-butyl group, a pentyl group, a hexyl group, a heptyl group, an octyl group and a 2-ethylhexyl group. Preferred examples thereof include a methyl group, an ethyl group, a propyl group and an isopropyl group. The number of alkyl substituents in the benzene ring is preferably 1 or more and 3 or less and more preferably one. Alkyl substituents are each independently selected from the group consisting of aforementioned alkyl groups.

The ketone groups of a benzene ring of the quinone-based compound may be reduced into hydroxyl groups and further one of the hydroxyl groups may be alkoxylated. Examples of the alkoxy group is preferably an alkoxy group having 1 or more and 3 or less carbon atoms, more preferably, a methoxy group, an ethoxy group and a propoxy group and further preferably a methoxy group.

Preferred examples of the quinone-based compound include hydroquinone substituted by a hydroxyl group or an alkyl group, p-benzoquinone substituted by a hydroxyl group or an alkyl group and an alkyl resorcinol. Further preferably, the quinone-based compounds represented by the following formulas (I), (II) and (IV) are mentioned.

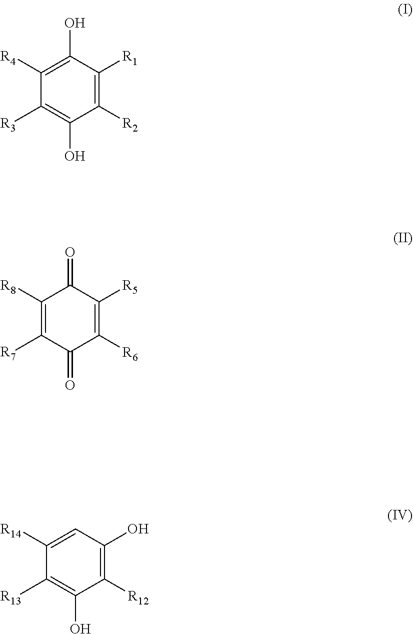

In the formula (I), R₁ represents a hydroxyl group or a linear or branched alkyl group having from 1 to 4 carbon atoms; and R₂, R₃ and R₄ each independently represent hydrogen or a methyl group. In a preferred embodiment, R₁ represents a hydroxyl group or a linear or branched alkyl group having from 1 to 4 carbon atoms; and R₂, R₅ and R₄ all represent hydrogen. The linear or branched alkyl group having from 1 to 4 carbon atoms is preferably a methyl group, an ethyl group, a propyl group, an isopropyl group, a butyl group or a t-butyl group. In another preferred embodiment, R₁ represents a methyl group, R₃ represents hydrogen and one of R₂ and R₄ represent a methyl group and the other represents hydrogen or both represent a methyl group. In another preferred embodiment, R₁, R₂, R₃ and R₄ all represent a methyl group.

In the formula (II), R₅ represents a hydroxyl group or a linear or branched alkyl group having from 1 to 4 carbon atoms; and R₆, R₇ and R₈ each independently represent hydrogen or a methyl group. In a preferred embodiment, R₅ represents a linear or branched alkyl group having from 1 to 4 carbon atoms; and R₆, R₇, and R₈ all represent hydrogen. The linear or branched alkyl group having from 1 to 4 carbon atoms is preferably a methyl group, an ethyl group, a propyl group, an isopropyl group, a butyl group or a t-butyl group.

In the formula (IV), R₁₂, R₁₃ and R₁₄ each independently represent hydrogen or a linear or branched alkyl group having from 1 to 8, preferably from 1 to 6 carbon atoms. The linear or branched alkyl group is preferably selected from the group consisting of a methyl group, an ethyl group, a propyl group, an isopropyl group, a butyl group, a t-butyl group, a pentyl group, a hexyl group, a heptyl group, an octyl group and a 2-ethylhexyl group. However, R₁₂, R₁₃ and R₁₄ do not simultaneously represent hydrogen. In a preferred embodiment, any one of R₁₂, R₁₃ and R₁₄ represents a linear or branched alkyl group having from 1 to 6 carbon atoms and the others both represent hydrogen. More preferably, any one of R₁₂, R₁₃ and R₁₄ is a linear or branched alkyl group having from 1 to 5 carbon atoms and both of the other represent hydrogen. More preferably, R₁₂, R₁₃ and R₁₄ each independently represent hydrogen or a linear or branched alkyl group having from 1 to 5 carbon atoms. However, R₁₂, R₁₃ and R₁₄ do not simultaneously represent hydrogen. More specifically, the compound represented by formula (IV) is preferably a compound represented by formula (III), in view of solubility.

Further preferably, any one of R₁₂, R₁₃ and R₁₄ represents a linear or branched alkyl group having from 2 to 5 carbon atoms and the others both represent hydrogen. In another preferred embodiment, any two of R₁₂, R₁₃ and R₁₄ are a linear alkyl group having from 1 to 6 carbon atoms and the other represents hydrogen. More preferably, any two of R₁₂, R₁₃ and R₁₄ represent a linear alkyl group having from 1 to 5 carbon atoms and the other represents hydrogen. Further preferably, any two of R₁₂, R₁₃ and R₁₄ represent a linear alkyl group having from 2 to 5 carbon atoms and the other represents hydrogen. In formula (IV), the linear or branched alkyl group represented by R₁₂, R₁₃ or R₁₄ preferably represents a group selected from the group consisting of a methyl group, an ethyl group, a propyl group, an isopropyl group, a butyl group and a t-butyl group.

The quinone-based compound to be used in the composition of the present invention may be any one compound or combination of any two or more compounds selected from the aforementioned quinone-based compounds. Preferably, the quinone-based compound is any one compound or any combination of any two or more compounds selected from the compounds represented by the formulas (I), (II) and (IV).

Further preferred examples of the quinone-based compound include, one or more compounds selected from the group consisting of p-benzoquinones and hydroquinones such as p-toluquinone, 2-methylhydroquinone, ethylquinol, 2-butylhydroquinone, tert-butylhydroquinone, 2,6-dimethylhydroquinone, 2,3-dimethylhydroquinone, 2,3,5-trimethylhydroquinone, tetramethylhydroquinone, hydroxyhydroquinone, 3,5-dimethylbenzoquinone, tert-butylbenzoquinone; and alkyl resorcinols such as 4-butylresorcinol (rucinol), 4-hexylresorcinol, 5-methylresorcinol, 5-pentylresorcinol, 2-propylresorcinol, 2,5-dimethylresorcinol, 2-methylresorcinol and 4-isopropylresorcinol. Among them, one or more compounds selected from the group consisting of p-toluquinone and 2-methylhydroquinone is preferred in view of inhibition of biofilm formation.

### (2-1-2. Chelating Agent)

As the chelating agent to be used in the biofilm formation inhibition composition of the present invention comprising a quinone-based compound and a chelating agent, there may be mentioned a carboxylic acid-based, phosphoric acid-based or phosphonic acid-based chelating agent. Examples of the carboxylic acid-based chelating agent include polycarboxylic acid, hydroxycarboxylic acid, aminocarboxylic acid, phosphonocarboxylic acid and salts of these. Examples of the polyvalent carboxylic acid include citric acid, succinic acid, malic acid, fumaric acid, tartaric acid, malonic acid and maleic acid. Examples of the hydroxycarboxylic acid include aliphatic hydroxycarboxylic acids such as citric acid and malic acid. Examples of the aminocarboxylic acid include ethylenediaminetetraacetic acid (EDTA), nitrilotriacetic acid (NTA), iminodiacetic acid, diethylenetriaminepentaacetic acid (DPTA), N-hydroxyethyl-ethylenediaminetriacetic acid (HEDTA), methylglycine diacetic acid (MGDA), aspartic acid diacetic acid (ASDA) and glutamic acid diacetic acid (GLDA). Examples of the phosphonocarboxylic acid include 2-phosphonobutane-1,2,4-tricarboxylic acid. Examples of the phosphoric acid-based chelating agent include tripolyphosphoric acid and a salt thereof. Examples of the phosphonic acid-based chelating agent include hydroxyphosphonic acid such as 1-hydroxyethane-1,1-diphosphonic acid (HEDP), aminophosphonic acid such as aminotrimethylenephosphonic acid (ATMP) and salts of these. Among them, one or more compounds selected from the group consisting of aminocarboxylic acid, phosphonocarboxylic acid, hydroxycarboxylic acid, hydroxyphosphonic acid and salts of these is preferred as the chelating agent to be used in the composition of the present invention. Examples of the salts include an alkali metal salt, an ammonium salt and an amine salt. The salt is preferably an alkali metal salt and more preferably a sodium salt or a potassium salt.

### (2-1-3. Composition)

The biofilm formation inhibition composition of the present invention comprising a quinone-based compound and a chelating agent may be a composition consisting of a quinone-based compound and a chelating agent and may comprise other components. For example, from the view point of mixing the quinone-based compound and the chelating agent, the biofilm formation inhibition composition can comprise a solvent such as water and an organic solvent other than them. Preferred organic solvents include methanol, ethanol, dipropylene glycol, diethylene glycol, diacetone alcohol, diethylene glycol monomethyl ether, propylene glycol and a mixture of these solvents.

Further, examples of the other components which may be comprised in the biofilm formation inhibition composition include an antimicrobial/antifungal agent, an antiseptic/antifungal agent, an antibiotic substance, a penetration enhancer, a surfactant, a deodorant and a fragrance. The types and concentrations of the other components are not particularly limited as long as a biofilm formation inhibitory effect by a quinone-based compound and a chelating agent is not inhibited.

The content of a quinone-based compound in the biofilm formation inhibition composition, in view of the solubility of a quinone-based compound and biofilm formation inhibitory effect, is preferably 0.1% by mass or more, more preferably 0.5% by mass or more, further preferably 1% by mass or more, further preferably 3% by mass or more and further preferably 5% by mass or more; and preferably 90% by mass or less, more preferably 70% by mass or less, further preferably 50% by mass or less, further preferably 30% by mass or less and further preferably 20% by mass or less. Alternatively, the content of a quinone-based compound in the biofilm formation inhibition composition of the present invention is preferably from 0.1 to 90% by mass, more preferably from 0.5 to 70% by mass, further preferably from 1 to 50% by mass, further preferably from 1 to 30% by mass, further preferably from 1 to 20% by mass, further preferably from 3 to 20% by mass and further preferably from 5 to 20% by mass.

The content of a chelating agent in the biofilm formation inhibition composition, in view of the biofilm formation inhibitory effect, is preferably 0.05% by mass or more, more preferably 0.1% by mass or more, further preferably 0.3% by mass or more and further preferably 0.5% by mass or more; and preferably 90% by mass or less, more preferably 70% by mass or less, further preferably 50% by mass or less, further preferably 30% by mass or less and further preferably 20% by mass or less. Alternatively, the content of a chelating agent in the biofilm formation inhibition composition of the present invention is preferably from 0.05 to 90% by mass, more preferably from 0.05 to 70 by mass, further preferably from 0.1 to 50% by mass, further preferably from 0.3 to 30% by mass and further preferably from 0.5 to 20% by mass.

The contents of a quinone-based compound and a chelating agent in the biofilm formation inhibition composition are preferably from 0.1 to 90% by mass and from 0.05 to 90% by mass; more preferably from 1 to 50% by mass and from 0.1 to 50% by mass; further preferably from 1 to 20% by mass and from 0.3 to 30% by mass; further preferably from 3 to 20% by mass and from 0.3 to 30% by mass; and further preferably from 5 to 20% by mass and from 0.5 to 20% by mass; respectively.

The content of a chelating agent in the biofilm formation inhibition composition, in view of the biofilm formation inhibitory effect, is, preferably 0.1 part by mass or more relative to the quinone-based compound (100 parts by mass), more preferably 0.5 parts by mass or more, further preferably 1 part by mass or more, further preferably 3 parts by mass or more, further preferably 5 parts by mass or more and further preferably 7 parts by mass or more; however, in view of economic efficiency, the content of a chelating agent relative to the quinone-based compound (100 parts by mass) is preferably 5000 parts by mass or less, more preferably 2000 parts by mass or less, further preferably 1000 parts by mass or less, further preferably 700 parts by mass or less, further preferably 500 parts by mass or less and further preferably 300 parts by mass or less.

Alternatively, the content of a chelating agent in the biofilm formation inhibition composition relative to the quinone-based compound (100 parts by mass) is preferably from 0.1 to 5000 parts by mass, more preferably from 0.5 to 2000 parts by mass, further preferably from 1 to 1000 parts by mass, further preferably from 3 to 700 parts by mass, further preferably from 5 to 500 parts by mass and further preferably from 7 to 300 parts by mass.

The total content of a quinone-based compound and a chelating agent in the biofilm formation inhibition composition is preferably 1% by mass or more, more preferably 3% by mass or more, further preferably 5% by mass or more and further preferably 7% by mass or more; and preferably 100% by mass or less, more preferably 80% by mass or less, further preferably 50% by mass or less and further preferably 30% by mass or less. Alternatively, the total content of a quinone-based compound and a chelating agent in the biofilm formation inhibition composition is preferably from 1 to 100% by mass, more preferably from 3 to 80% by mass, further preferably from 5 to 50% by mass and further preferably from 7 to 30% by mass.

The biofilm formation inhibition composition may comprise an organic solvent as an optional component. The amount of the organic solvent in the composition is preferably 95% by mass or less and more preferably 93% by mass or less; and preferably 0% by mass or more, more preferably 30% by mass or more, further preferably 50% by mass or more and further preferably 70% by mass or more. Alternatively, the content of an organic solvent in the biofilm formation inhibition composition is preferably from 0 to 95% by mass, more preferably from 0 to 93% by mass, further preferably from 30 to 95% by mass, further preferably from 30 to 93% by mass, further preferably from 50 to 95% by mass, further preferably from 50 to 93% by mass, further preferably from 70 to 95% by mass and further preferably from 70 to 93% by mass.

### (2-1-4. Method for Inhibiting Biofilm Formation)

In an embodiment, the present invention provides a method for inhibiting biofilm formation using a quinone-based compound and chelating agent as mentioned above. Preferably, the method is a method for inhibiting biofilm formation in an aqueous system. The method of the embodiment comprises adding a quinone-based compound and a chelating agent as mentioned above in an aqueous liquid, preferably, the aqueous liquid to be used in the aforementioned aqueous system. In the method of the embodiment, the biofilm formation inhibition composition of the present invention comprising a quinone-based compound and a chelating agent as mentioned above may be added in the aqueous liquid; the composition is diluted with such as water or an organic solvent, and the diluted solution of the composition may be added; or the quinone-based compound and chelating agent as mentioned above may be separately added. The aqueous liquid comprising a quinone-based compound and a chelating agent hereinafter will be referred to simply as a “treatment solution” in the specification. The quinone-based compound is preferably a compound represented by the aforementioned formula (I), (II) or (IV), and a compound represented by any one of formulas (I) to (III) is preferred in view of solubility.

In the embodiment, the concentration of a quinone-based compound in the treatment solution, in view of inhibition of biofilm formation, is preferably 1 ppm or more, more preferably 2 ppm or more, further preferably 3 ppm or more, further preferably 5 ppm or more, further preferably 7 ppm or more, further preferably 8 ppm or more, further preferably 9 ppm or more and further preferably 10 ppm or more; however, in view of economic efficiency, the concentration of a quinone-based compound is preferably 1400 ppm or less, more preferably 1000 ppm or less, further preferably 500 ppm or less, further preferably 270 ppm or less, further preferably 200 ppm or less, further preferably 150 ppm or less, further preferably 100 ppm or less, further preferably 70 ppm or less, further preferably 60 ppm or less, further preferably 50 ppm or less, further preferably 40 ppm or less, further preferably 30 ppm or less, further preferably 20 ppm or less and further preferably 15 ppm or less.

Alternatively, the concentration of a quinone-based compound in a treatment solution is preferably from 1 to 1400 ppm, more preferably from 2 to 1000 ppm, more preferably from 3 to 500 ppm, further preferably from 5 to 270 ppm, further preferably from 5 to 200 ppm, further preferably from 5 to 150 ppm, further preferably from 5 to 100 ppm, further preferably from 5 to 70 ppm, further preferably from 5 to 60 ppm, further preferably from 5 to 50 ppm, further preferably from 5 to 40 ppm, further preferably from 5 to 30 ppm, further preferably from 5 to 20 ppm, further preferably from 7 to 20 ppm, further preferably from 8 to 20 ppm, further preferably from 9 to 20 ppm, further preferably from 10 to 20 ppm and further preferably from 10 to 15 ppm.

Note that preferably, in the method of the embodiment, a quinone-based compound is used such that the concentration of a quinone-based compound in the treatment solution becomes less than the minimum inhibitory concentrations (MIC) of biofilm causative microorganisms.

In the method of the embodiment, the concentration of a chelating agent in the treatment solution, in view of inhibition of biofilm formation, is preferably 0.05 ppm or more, more preferably 0.1 ppm or more, further preferably 0.3 ppm or more, further preferably 0.5 ppm or more, further preferably 1 ppm or more and further preferably 2 ppm or more; however, in view of economic efficiency, the concentration of a chelating agent in the treatment solution is preferably 1000 ppm or less, more preferably 500 ppm or less, further preferably 100 ppm or less, further preferably 70 ppm or less, further preferably 50 ppm or less, further preferably 40 ppm or less, further preferably 30 ppm or less, further preferably 25 ppm or less and further preferably 20 ppm or less.

Alternatively, the concentration of a chelating agent in the treatment solution is preferably from 0.05 to 1000 ppm, more preferably from 0.1 to 500 ppm, further preferably from 0.3 to 100 ppm, further preferably from 0.3 to 70 ppm, further preferably from 0.3 to 50 ppm, further preferably from 0.3 to 40 ppm, further preferably from 0.3 to 30 ppm, further preferably from 0.3 to 20 ppm, further preferably from 0.5 to 20 ppm, further preferably from 1 to 20 ppm and further preferably from 2 to 20 ppm.

The preferred concentrations of a quinone-based compound and a chelating agent in the treatment solution are preferably from 1 to 1400 ppm and from 0.05 to 1000 ppm; more preferably from 5 to 200 ppm and from 0.3 to 100 ppm; further preferably from 5 to 50 ppm and from 0.3 to 30 ppm; and further preferably from 5 to 30 ppm and from 0.5 to 20 ppm; respectively.

In the method of the embodiment, the amount of a chelating agent to be added in an aqueous liquid, in view of inhibition of biofilm formation, is preferably 0.1 part by mass or more relative to a quinone-based compound (100 parts by mass), more preferably 0.5 parts by mass or more, further preferably 1 part by mass or more, further preferably 3 parts by mass or more, further preferably 5 parts by mass or more and further preferably 7 parts by mass or more; however, in view of economic efficiency, the amount of a chelating agent to be added relative to a quinone-based compound (100 parts by mass) is preferably 5000 parts by mass or less, more preferably 2000 parts by mass or less, further preferably 1000 parts by mass or less, further preferably 700 parts by mass or less, further preferably 500 parts by mass or less and further preferably 300 parts by mass or less.

Alternatively, in the method of the embodiment, the amount of a chelating agent to be added in an aqueous liquid relative to a quinone-based compound (100 parts by mass) is, preferably, from 0.1 to 5000 parts by mass, more preferably from 0.5 to 2000 parts by mass, further preferably from 1 to 1000 parts by mass, further preferably from 3 to 700 parts by mass, further preferably from 5 to 500 parts by mass and further preferably from 7 to 300 parts by mass.

In the method of the embodiment, it is not necessary to always maintain the concentrations of a quinone-based compound and a chelating agent in the treatment solution within the aforementioned predetermined ranges and the concentrations may be, as necessary or periodically, controlled to fall within the aforementioned range and maintained for a predetermined time. For example, a quinone-based compound and a chelating agent can be simultaneously or separately added in an aqueous liquid. In view of biofilm formation inhibitory effect, the concentrations of a quinone-based compound and a chelating agent in the treatment solution are desirably maintained within the aforementioned predetermined ranges, preferably for 24 hours or more, more preferably for 36 hours or more and further preferably for 40 hours or more. The time for maintaining the concentrations of a quinone-based compound and a chelating agent within the aforementioned predetermined range according to the method of the embodiment, is preferably 240 hours or less and more preferably 120 hours or less.

In the method of the embodiment, the temperature of the aqueous liquid to be treated and the temperature of the treatment solution, which can be appropriately set in accordance with the aqueous system in which the aqueous liquid is to be used, are, each independently, preferably 5° C. or more, more preferably 10° C. or more, further preferably 15° C. or more, further preferably 20° C. or more and further preferably 25° C. or more; and preferably 60° C. or less, more preferably 55° C. or less and further preferably 50° C. or less.

### (2-1-5. Use)

As a further embodiment, the present invention provides combined use of a quinone-based compound and a chelating agent for inhibiting biofilm formation. Preferably, a composition comprising a quinone-based compound and a chelating agent is used for inhibiting biofilm formation. Preferably, the use is use for inhibiting biofilm formation in an aqueous system or an aqueous liquid. The types and concentrations for use of the quinone-based compound and the chelating agent and how to use them are the same as mentioned above.

### (2-2. Combined Use of Quinone-Based Compound and Organic Solvent)

In another embodiment, the biofilm formation inhibition composition of the present invention comprises a quinone-based compound and an organic solvent.

### (2-2-1. Quinone-Based Compound)

As the quinone-based compound to be used in the biofilm formation inhibition composition of the present invention comprising a quinone-based compound and an organic solvent, the quinone-based compounds mentioned in the above section 2-1-1 are mentioned. More specifically, the quinone-based compound is preferably a compound represented by the aforementioned formula (I), (II) or (IV) and preferably a compound represented by any one of the aforementioned formulas (I) to (III), in view of solubility.

### (2-2-2. Organic Solvent)

The organic solvent to be used in the biofilm formation inhibition composition of the present invention comprising a quinone-based compound and an organic solvent, which is not particularly limited in type, may be aliphatic or aromatic. In order to dissolve the quinone-based compound and stabilize it, C log P value of the organic solvent is preferably −3 or more, more preferably −2.5 or more and further preferably −2 or more; and preferably 4 or less, more preferably 3.5 or less and further preferably 3 or less. Alternatively, C log P value of the organic solvent is preferably from −3 to 4, more preferably from −3 to 3.5, further preferably from −3 to 3, further preferably from −2.5 to 3 and further preferably from −2 to 3.

In the specification, the C log P value refers to a yardstick representing partition of a substance between an octanol phase and an aqueous phase. The C log P value refers to a calculated value representing an octanol-water partition coefficient (log P) in accordance with EPIWEB4.1 (US EPA):

log P=log([substance]octanol/[(substance]water)

In the above formula, [substance]octanol represents a mol concentration of a substance in the 1-octanol phase; and [substance] water represents a mol concentration of a substance in the aqueous phase.

Preferably, the organic solvent is an alcohol-based organic solvent or an ether-based organic solvent, more preferably, an aliphatic alcohol-based organic solvent or an aliphatic ether-based organic solvent. Further preferably, the organic solvent is a glycol-based organic solvent. Of them, a compound having two hydroxyl groups or an ether thereof is preferred. Preferred examples of the glycol-based organic solvent include a mono and polyalkylene glycol monoalkyl ether. Examples of the alkylene glycol include ethylene glycol, propylene glycol and butylene glycol. The term “poly” refers to polymerization of preferably 2 or more and 3 or less alkylene glycols. As the alkyl group of the alkyl ether, an alkyl group having preferably 1 or more and preferably 8 or less carbon atoms, more preferably 6 or less, further preferably 4 or less and, further preferably 2 or less is mentioned; or an alkyl group having preferably from 1 to 8, more preferably from 1 to 6, further preferably from 1 to 4 and further preferably from 1 to 2 carbon atoms, is mentioned.

The number of carbon atoms of the organic solvent is preferably 3 or more and more preferably 4 or more; and preferably 12 or less, more preferably 8 or less and further preferably 6 or less. Alternatively, the number of carbon atoms of the organic solvent is preferably from 3 to 12, more preferably from 3 to 8, further preferably from 3 to 6 and further preferably from 4 to 6.

Preferred examples of the organic solvent include ethylene glycol mono(2-ethylhexyl)ether (2.46), 1-phenoxy-2-propanol (1.52), 2-phenoxyethanol (1.1), 1-butoxy-2-propanol (0.98), ethylene glycol monobutyl ether (0.57), 2-isobutoxyethanol (0.49), 2-(2-n-butoxyethoxy)ethanol (0.29), propylene glycol (−0.78), 2-2-isobutoxyethoxy)ethanol (0.22), triethylene glycol monobutyl ether (0.02), diacetone alcohol (−0.34), 2-ethoxyethanol (−0.42), 1-methoxy-2-p-propernol (−0.49), dipropylene glycol (−0.64), 2-(2-ethoxyethoxy)ethanol (−0.69), 2-methoxyethanol (−0 91), diethylene glycol monomethyl ether (−1.18), diethylene glycol (−1.47), triethylene glycol monomethyl ether (−1.46) and diethylene glycol monomethyl ether (−1.74). More preferred examples include dipropylene glycol (−0.64), diethylene glycol (−1.47), diacetone alcohol (−0.34), diethylene glycol monomethyl ether (−1.18) and propylene glycol (−0.78). Note that, the numerical values within parentheses above are C log P values.

The biofilm formation inhibition composition of the present invention comprising a quinone-based compound and an organic solvent can comprise any one or combination of any two or more of the organic solvents as mentioned above.

### (2-2-3. Composition)

The biofilm formation inhibition composition of the present invention comprising a quinone-based compound and an organic solvent may be a composition consisting of a quinone-based compound and an organic solvent as mentioned above; however, the composition may comprise other components. Examples of the other components include water, an antimicrobial/antifungal agent, an antiseptic/antifungal agent, an antibiotic substance, a penetration enhancer, a surfactant, a deodorant and a fragrance.

The biofilm formation inhibition composition comprising a quinone-based compound and an organic solvent preferably comprises no chelating agent. The chelating agents, include such as carboxylic acid type, phosphate type or phosphonic acid type chelating agent. Examples of the carboxylic acid type chelating agent include a polyvalent carboxylic acid, a hydroxycarboxylic acid, an aminocarboxylic acid and a phosphonocarboxylic acid and salts thereof. Examples of the polyvalent carboxylic acid include citric acid, succinic acid, malic acid, fumaric acid, tartaric acid, malonic acid and maleic acid. Examples of the hydroxycarboxylic acid include aliphatic hydroxycarboxylic acids such as citric acid and malic acid. Examples of the aminocarboxylic acid include ethylenediaminetetraacetic acid (EDTA), nitrilotriacetic acid (NTA), iminodiacetic acid, diethylenetriaminepentaacetic acid (DPTA), N-hydroxyethyl-ethylenediaminetriacetic acid (HEDTA), methylglycinediacetic acid (MGDA), aspartic acid diacetic acid (ASDA) and glutamic acid diacetic acid (GLDA). Examples of the phosphonocarboxylic acid include 2-phosphonobutane-1,2,4-tricarboxylic acid. Examples of phosphoric acid-based chelating agent include such as tripolyphosphoric acid and a salt thereof. Examples of the phosphonic acid chelating agent include a hydroxyphosphonic acid such as 1-hydroxyethane-1,1-diphosphonic acid (HEDP), an aminophosphonic acid such as aminotrimethylenephosphonic acid (ATMP) and salts of these. Examples of the salts include salts of alkali metals such as sodium and potassium, an ammonium salt and an amine salt.

The content of a quinone-based compound in the biofilm formation inhibition composition, in view of the solubility and stability of a quinone-based compound and the biofilm formation inhibitory effect, is preferably 0.1% by mass or more, more preferably 0.5% by mass or more, further preferably 1% by mass or more, further preferably 3% by mass or more and further preferably 5% by mass or more; and preferably 90% by mass or less, more preferably 70% by mass or less, further preferably 50% by mass or less, further preferably 30% by mass or less and further preferably 20% by mass or less. Alternatively, the content of a quinone-based compound in the biofilm formation inhibition composition is preferably from 0.1 to 90% by mass, more preferably from 0.5 to 70% by mass, further preferably from 1 to 50% by mass, further preferably from 1 to 30% by mass, further preferably from 1 to 20% by mass, further preferably from 3 to 20% by mass and further preferably from 5 to 20% by mass.

The content of an organic solvent in the biofilm formation inhibition composition, in view of the solubility and stability of a quinone-based compound and the biofilm formation inhibitory effect, is preferably 10% by mass or more, more preferably 30% by mass or more, further preferably 50% by mass or more, further preferably 60% by mass or more, further preferably 70% by mass or more and further preferably 80% by mass or more; and preferably 99.9% by mass or less, more preferably 99.5% by mass or less, further preferably 99% by mass or less, further preferably 97% by mass or less and further preferably 95% by mass or less. Alternatively, the content of an organic solvent in the biofilm formation inhibition composition is preferably from 10 to 99.9% by mass, more preferably from 30 to 99.5% by mass, further preferably 50 to 99.5% by mass, further preferably from 60 to 99% by mass, further preferably from 70 to 99% by mass, further preferably from 80 to 97% by mass and further preferably from 80 to 95% by mass.

The contents of a quinone-based compound and an organic solvent in the biofilm formation inhibition composition are preferably from 0.1 to 90% by mass and from 10 to 99.9% by mass; more preferably from 1 to 50% by mass and from 50 to 99.5% by mass; further preferably from 1 to 30% by mass and from 70 to 99% by mass, further preferably from 1 to 20% by mass and from 80 to 95% by mass; and further preferably from 5 to 20% by mass and from 80 to 95% by mass; respectively.

The mass ratio of an organic solvent relative to a quinone-based compound in the biofilm formation inhibition composition (mass of anorganic solvent/mass of quinone-based compound), in view of handling of the quinone-based compound, is preferably 500 or less, more preferably 200 or less, further preferably 150 or less, further preferably 100 or less, further preferably 50 or less and further preferably 20 or less; and, in view of the solubility and stability of the quinone-based compound, is preferably 0.1 or more, more preferably 0.5 or more, further preferably one or more, further preferably 2 or more and further preferably 3 or more. Alternatively, the mass ratio of an organic solvent relative to a quinone-based compound in the biofilm formation inhibition composition is preferably from 0.1 to 500, more preferably from 0.5 to 200, further preferably from 1 to 150, further preferably from 2 to 100, further preferably from 3 to 50 and further preferably from 3 to 20.

The total content of a quinone-based compound and an organic solvent in the biofilm formation inhibition composition, in view of inhibition of biofilm formation and the solubility and stability of a quinone-based compound, is preferably 50% by mass or more, more preferably 70% by mass or more, further preferably 80% by mass or more, further preferably 85% by mass or more, further preferably 90% by mass or more, further preferably 95% by mass or more, further preferably 99 t by mass or more and preferably 100% by mass or less.

The biofilm formation inhibition composition may comprise water as an optional component. The content of water in the composition, in view of the solubility and stability of a quinone-based compound, is preferably 50% by mass or less, more preferably 30% by mass or less, further preferably 10% by mass or less, further preferably 5% by mass or less and further preferably 1% by mass or less; and preferably 0% by mass or more.

### (2-2-4. Method for Inhibiting Biofilm Formation)

In an embodiment, the present invention provides a method for inhibiting biofilm formation using the biofilm formation inhibition composition comprising a quinone-based compound and an organic solvent described above. Preferably, the method is a method for inhibiting biofilm formation in an aqueous system. The method of the embodiment comprises adding the biofilm formation inhibition composition of the present invention comprising a quinone-based compound and an organic solvent described above in an aqueous liquid preferably aqueous liquids used in the aforementioned aqueous systems. In the method of the embodiment, when the composition of the present invention is added in the aqueous liquid, the quinone-based compound and the organic solvent are mixed in advance and the composition thus obtained may be added in the aqueous liquid; or the composition is diluted with e.g., water or an organic solvent and the diluted solution may be added; or the quinone-based compound and the organic solvent may be separately added in the aqueous liquid. In order to stably maintain a quinone-based compound, it is preferred to add a composition comprising the quinone-based compound and the organic solvent previously prepared. The aqueous liquid comprising the quinone-based compound and organic solvent will be also referred to simply as a “treatment solution” in the specification.

In the embodiment, the concentration of a quinone-based compound in the treatment solution, in view of inhibition of biofilm formation, is preferably 1 ppm or more, more preferably 2 ppm or more, further preferably 3 ppm or more, further preferably 5 ppm or more, further preferably 7 ppm or more, further preferably 8 ppm or more, further preferably 9 ppm or more and further preferably 10 ppm or more; in view of economic efficiency, the concentration is preferably 1400 ppm or less, more preferably 1000 ppm or less, further preferably 500 ppm or less, further preferably 270 ppm or less, further preferably 200 ppm or less, further preferably 150 ppm or less, further preferably 100 ppm or less, further preferably 70 ppm or less, further preferably 60 ppm or less, further preferably 50 ppm or less, further preferably 40 ppm or less, further preferably 30 ppm or less, further preferably 20 ppm or less and further preferably 15 ppm or less.

Alternatively, the concentration of a quinone-based compound in the treatment solution is preferably from 1 to 1400 ppm, more preferably from 2 to 1000 ppm, more preferably from 3 to 500 ppm, further preferably from 5 to 270 ppm, further preferably from 5 to 200 ppm, further preferably from 5 to 150 ppm, further preferably from 5 to 100 ppm, further preferably from 5 to 70 ppm, further preferably from 5 to 60 ppm, further preferably from 5 to 50 ppm, further preferably from 5 to 40 ppm, further preferably from 5 to 30 ppm, further preferably from 5 to 20 ppm, further preferably from 7 to 20 ppm, further preferably from 8 to 20 ppm, further preferably from 9 to 20 ppm, further preferably from 10 to 20 ppm and further preferably from 10 to 15 ppm.

Note that, in the method of the embodiment, a quinone-based compound is preferably used such that the concentration of the quinone-based compound in the treatment solution becomes less than the minimum inhibitory concentrations (MIC) of biofilm causative microorganisms.

In the method of the embodiment, the concentration of an organic solvent in the treatment solution varies depending on the content of a quinone-based compound in the treatment solution. In order not to inhibit the biofilm formation inhibitory effect by the quinone-based compound, the concentration of an organic solvent is preferably 0.5% by mass or less, more preferably 0.2% by mass or less, further preferably 0.1% by mass or less, further preferably 0.05% by mass or less, further preferably 0.01% by mass or less and preferably 0.00001% by mass or more (0.1 ppm or more).

Preferred concentrations of a quinone-based compound and an organic solvent in the treatment solution are preferably from 1 to 1400 ppm and from 0.1 to 5000 ppm; more preferably from 5 to 200 ppm and from 0.1 to 2000 ppm; further preferably from 5 to 50 ppm and from 0.1 to 1000 ppm; and further preferably from 5 to 30 ppm and from 0.1 to 500 ppm, respectively.

In the method of the embodiment, the mass ratio (mass of organic solvent/mass of quinone-based compound) of an organic solvent relative to the quinone-based compound in a treatment solution, in order not to inhibit the biofilm formation inhibitory effect by the quinone-based compound, is preferably 500 or less, more preferably 200 or less, further preferably 150 or less, further preferably 100 or less, further preferably 50 or less and further preferably 20 or less; and preferably 0.1 or more, more preferably 0.5 or more, further preferably 1 or more, further preferably 2 or more and further preferably 3 or more. Alternatively, in the present invention, the mass ratio of an organic solvent relative to the quinone-based compound in the treatment solution is preferably from 0.1 to 500, more preferably from 0.5 to 200, further preferably from 1 to 150, further preferably from 2 to 100, further preferably from 3 to 50 and further preferably from 3 to 20.

In the method of the embodiment, it is not necessary to always maintain the concentrations of a quinone-based compound and an organic solvent in a treatment solution within the aforementioned predetermined ranges and the concentrations are, as necessary or periodically, controlled to fall within the aforementioned ranges and maintained for a predetermined time. For example, a quinone-based compound and an organic solvent can be simultaneously or separately added in an aqueous liquid. In view of biofilm formation inhibitory effect, the concentrations of a quinone-based compound and an organic solvent in the treatment solution are desirably maintained within the aforementioned predetermined ranges, preferably for 24 hours or more, more preferably 36 hours or more and further preferably 40 hours or more. The time for maintaining the concentrations of a quinone-based compound and an organic solvent within the aforementioned predetermined range in the method of the embodiment is preferably 240 hours or less and more preferably 120 hours or less.

In the method of the embodiment, the temperature of the aqueous liquid to be treated and the temperature of the treatment solution, which can be appropriately set in accordance with the aqueous system in which the aqueous liquid is used, are each independently preferably 5° C. or more, more preferably 10° C. or more, further preferably 15° C. or more, further preferably 20° C. or more and further preferably 25° C. or more; and preferably 60° C. or less, more preferably 55° C. or less and further preferably 50° C. or less.

### (2-2-5. Use)

As still another embodiment, the present invention provides combined use of a quinone-based compound and an organic solvent for inhibiting biofilm formation. Preferably, the biofilm formation inhibition composition of the present invention comprising a quinone-based compound and an organic solvent described above is used for inhibiting biofilm formation. Preferably, the use is use for inhibiting biofilm formation in an aqueous system or an aqueous liquid. The types and use concentrations of the quinone-based compound and organic solvent and how to use them are the same as mentioned above.

### 3. Exemplary Embodiment

The present invention includes, as exemplary embodiments, the following substances, production methods, uses and methods. Note that, the present invention is not limited to these embodiments.

[1] A biofilm formation inhibitor comprising at least one compound selected from the group consisting of a hydroquinone substituted by a hydroxyl group or an alkyl group, a p-benzoquinone substituted by a hydroxyl group or an alkyl group and a C1 to C5 alkyl resorcinol, as active ingredient.
[2] The biofilm formation inhibitor according to [1], preferably comprising at least one quinone compound selected from the group consisting of the hydroquinone substituted by a hydroxyl group or an alkyl group and the p-benzoquinone substituted by a hydroxyl group or an alkyl group.
[3] The biofilm formation inhibitor according to [2], preferably comprising 270 ppm or less of the quinone compound, as an active ingredient.
[4] The biofilm formation inhibitor according to [1], preferably comprising the C1 to C5 alkyl resorcinol as an active ingredient.
[5] The biofilm formation inhibitor according to [4], preferably comprising 1400 ppm or less of the C1 to C5 alkyl resorcinol, as an active ingredient.
[6] The biofilm formation inhibitor according to any one of [1] to [5], preferably comprising at least one compound selected from the group consisting of the hydroquinone, the p-benzoquinone and the C1 to C5 alkyl resorcinol, as an active ingredient, at a concentration of less than the minimum inhibitory concentration of a main causative microorganism of a biofilm.
[7] The biofilm formation inhibitor according to any one of [1] to [5], preferably comprising at least one compound selected from the group consisting of the hydroquinone, the p-benzoquinone and the C1 to C5 alkyl resorcinol, as an active ingredient, at a concentration with which the growth inhibition rate of a main causative microorganism of a biofilm becomes 20% or less.
[8] The biofilm formation inhibitor according to any one of [1] to [7], preferably being a non-antimicrobial biofilm formation inhibitor.
[9] A method for inhibiting biofilm formation, comprising adding at least one compound selected from the group consisting of a hydroquinone substituted by a hydroxyl group or an alkyl group, a p-benzoquinone substituted by a hydroxyl group or an alkyl group and a C1 to C5 alkyl resorcinol, in target water.
[10] The method according to [9], preferably comprising adding at least one quinone compound selected from the group consisting of the hydroquinone substituted by a hydroxyl group or an alkyl group and the p-benzoquinone substituted by a hydroxyl group or an alkyl group, in target water.
[11] The method according to [10], preferably comprising the quinone compound in the target water at a concentration of 270 ppm or less.
[12] The method according to [9], preferably comprising adding the C1 to C5 alkyl resorcinol in target water.
[13] The method according to [12], preferably comprising adding the C1 to C5 alkyl resorcinol in the target water at a concentration of 1400 ppm or less.
[14] The method according to any one of [9] to [13], preferably comprising adding at least one compound selected from the group consisting of the hydroquinone, the p-benzoquinone and the C1 to C5 alkyl resorcinol, in the target water, at a concentration of less than the minimum inhibitory concentration of a main causative microorganism of a biofilm.
[15] The method according to any one of [9] to [13], preferably comprising adding at least one compound selected from the group consisting of the hydroquinone, the p-benzoquinone and the C1 to C5 alkyl resorcinol, in the target water, at a concentration with which the growth inhibition rate of a main causative microorganism of a biofilm becomes 20% or less.
[16] The method according to any one of [9] to [15], in which the concentration of at least one compound selected from the group consisting of the hydroquinone, the p-benzoquinone and the C1 to C5 alkyl resorcinol in the target water is preferably maintained for 24 hours or more.
[17] The method according to any one of [9] to [16], in which formation of a biofilm is preferably inhibited in an anti-microbial manner.
[18] In any one of [1] to [3], [6] to [11] and [14] to [17], preferably, the hydroquinone is a compound represented by formula (I) and the p-benzoquinone is compound represented by formula (II):

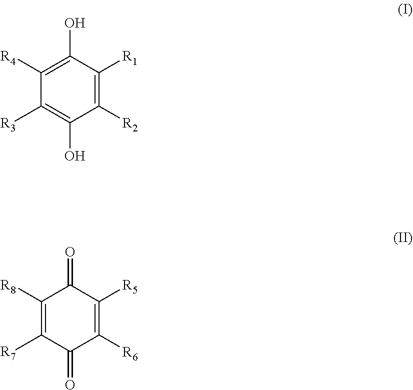

in the formulas, R₁ and R₅ each independently represent a hydroxyl group or a linear or branched alkyl group having from 1 to 4 carbon atoms; and R₂, R₃, R₄, R₆, R₇ and R₈ each independently represent hydrogen or a methyl group.
[19] In [18], preferably, in the formula (I),

R₁ represents a hydroxyl group or a linear or branched alkyl group having from 1 to 4 carbon atoms and R₂, R₃ and R₄ all represent hydrogen;

R₁ represents a methyl group, R₃ represents hydrogen and one of R₂ and R₄ represents a methyl group and the other represents hydrogen or both represent a methyl group; or

R₁, R₂, R₃ and R₄ all represent a methyl group.

[20] In [18], preferably, in the formula (II), R₅ represents a linear or branched alkyl group having from 1 to 4 carbon atoms and R₆, R₇, and R₈ all represent hydrogen.
[21] In any one of [1] to [3], [6] to [11] and [14] to [17], preferably, the quinone compound is at least one selected from the group consisting of p-toluquinone, 2-methylhydroquinone, ethylquinol, 2-butylhydroquinone, tert-butylhydroquinone, 2,6-dimethylhydroquinone, 2,3-dimethylhydroquinone, 2,3,5-trimethylhydroquinone, tetramethylhydroquinone, hydroxyhydroquinone, 3,5-dimethylbenzoquinone and tert-butylbenzoquinone.
[22] In any one of [1], [4] to [9] and [12] to [21], preferably, the C1 to C5 alkyl resorcinol is a compound represented by formula (III):

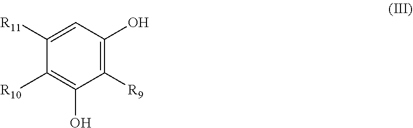

in the formula, R₉, R₁₀ and R₁₁ each independently represent hydrogen or a linear or branched alkyl group having from 1 to 5 carbon atoms; however R₉, R₁₀ and R₁₁ do not simultaneously represent hydrogen.
[23] In [22], preferably, any one of R₉, R₁₀ and R₁₁ represents a linear or branched alkyl group having from 1 to 5 carbon atoms and the others both represent hydrogen.
[24] In [22], preferably, any two of R₉, R₁₀ and R₁₁ represent a linear alkyl group having from 1 to 5 carbon atoms and the other represents hydrogen.
[25] In any one of [1], [4] to [9] and [12] to [21], preferably, the C1 to C5 alkyl resorcinol is at least one selected from the group consisting of 4-butylresorcinol (rucinol), 5-methylresorcinol, 5-pentyiresorcinol, 2-propylresorcinol, 2,5-dimethylresorcinol, 2-methylresorcinol and 4-isopropylresorcinol.
[26] In any one of [1] to [25], the biofilm is

preferably a biofilm comprising a gram negative microorganism, and

more preferably, a biofilm comprising at least one microorganism selected from the group consisting of Pseudomonas aeruginosa, the genus Sphingomonas and the genus Sphingopyxis, the genus Klebsiella, the genus Flavobacterium and the genus Roseomonas.

[27] In any one of [1] to [26], the biofilm is preferably a biofilm in a facility functioning by supplying or storing water or a biofilm in water flowing or storing in the facility.
[28] Use of at least one compound selected from the group consisting of a hydroquinone substituted by a hydroxyl group or an alkyl group, a p-benzoquinone substituted by a hydroxyl group or an alkyl group and a C1 to C5 alkyl resorcinol, for inhibiting biofilm formation.
[29] Use according to [28], in which preferably at least one quinone compound selected from the group consisting of the hydroquinone substituted by a hydroxyl group or an alkyl group and the p-benzoquinone substituted by a hydroxyl group or an alkyl group, is used.
[30] Use according to [28], in which preferably the C1 to C5 alkyl resorcinol is used.
[31] A biofilm formation inhibition composition comprising a quinone-based compound and a chelating agent.
[32] The composition according to [31], preferably, used for inhibiting biofilm formation in an aqueous liquid or an aqueous system using an aqueous liquid.
[33] A method for inhibiting biofilm formation comprising adding a quinone-based compound and a chelating agent in an aqueous liquid.
[34] The method according to [33], preferably, inhibiting biofilm formation in the aqueous liquid or an aqueous system using the aqueous liquid.
[35] Use of a quinone-based compound and a chelating agent in combination for inhibiting biofilm formation.
[36] Use according to [35], in which the use is preferably use for inhibiting biofilm formation in an aqueous liquid or an aqueous system using an aqueous liquid.
[37] Use according to [35] or [36], in which preferably a composition comprising a quinone-based compound and a chelating agent is used.
[38] In any one of the above [31] to [37], the chelating agent is

preferably, carboxylic acid-based, phosphoric acid-based or phosphonic acid-based chelating agent, and

more preferably, at least one selected from the group consisting of aminocarboxylic acid, phosphonocarboxylic acid, hydroxycarboxylic acid, hydroxyphosphonic acid and salts of these.

[39] In any one of [31] to [38], the quinone-based compound is preferably at least one compound selected from the group consisting of a hydroquinone substituted by a hydroxyl group or an alkyl group, a p-benzoquinone substituted by a hydroxyl group or an alkyl group and a C1 to C5 alkyl resorcinol.
[40] In any one of [31] to [38], the quinone-based compound is

preferably a compound having a single benzene ring having two or three ketone groups,

the ketone groups may be reduced into hydroxyl groups, further one of the hydroxyl groups may be alkoxylated,

the benzene ring is optionally substituted by one to three alkyl groups or preferably a single alkyl group, and

the alkyl groups each independently represent a linear or branched alkyl group having preferably 1 or more and 12 or less carbon atoms, more preferably 1 or more and 8 or less carbon atoms, further preferably 1 or more and 6 or less carbon atoms and further preferably 1 or more and 3 or less carbon atoms; or still preferably an alkyl group selected from the group consisting of a methyl group, an ethyl group, a propyl group, an isopropyl group, a butyl group, a t-butyl group, a pentyl group, a hexyl group, a heptyl group, an octyl group and a 2-ethylhexyl group.

[41] In any one of [31] to [38], the quinone-based compound is at least one selected from the group consisting of the compounds represented by formulas (I), (II) and (IV):

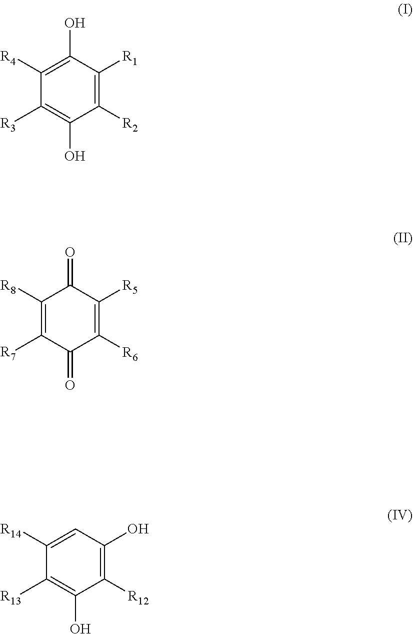

In formula (I),

R₁ represents a hydroxyl group or a linear or branched alkyl group having from 1 to 4 carbon atoms, and

R₂, R₃ and R₄ each independently represent hydrogen or a methyl group; and

more preferably,

R₁ is a hydroxyl group or a linear or branched alkyl group having from 1 to 4 carbon atoms and R₂, R₃ and R₄ all represent hydrogen,

R₁ represents a methyl group, R₃ represents hydrogen and one of R₂ and R₄ represents a methyl group and the other represents hydrogen, or both of R₂ and R₄ represent a methyl group, or,

R₁, R₂, R₃ and R₄ all represent a methyl group.

In formula (II),

R₅ represents a hydroxyl group or a linear or branched alkyl group having from 1 to 4 carbon atoms, and

R₆, R₇, and R₈ each independently represent hydrogen or a methyl group; and

more preferably, R₅ represents a linear or branched alkyl group having from 1 to 4 carbon atoms and R₆, R₇ and R₈ all represent hydrogen.

In formula (IV),

R₁₂, R₁₃ and R₁₄ each independently represent hydrogen or a linear or branched alkyl group having from 1 to 8 carbon atoms (provided that R₁₂, R₁₃ and R₁₄ do not simultaneously represent hydrogen);

more preferably, any one of R₁₂, R₁₃ and R₁₄ represents a linear or branched alkyl group having from 1 to 6 carbon atoms and the others both represent hydrogen, or any two of R₁₂, R₁₃ and R₁₄ represent a linear alkyl group having from 1 to 6 carbon atoms and the other represents hydrogen; and

further preferably, R₁₂, R₁₃ and R₁₄ each independently represent hydrogen or a linear or branched alkyl group having from 1 to 5 carbon atoms (provided that R₁₂, R₁₃ and R₁₄ do not simultaneously represent hydrogen).

[42] In any one of [31] to [41], the quinone-based compound is

preferably, at least one selected from the group consisting of p-toluquinone, 2-methylhydroquinone, ethylquinol, 2-butylhydroquinone, tert-butylhydroquinone, 2,6-dimethylhydroquinone, 2,3-dimethylhydroquinone, 2,3,5-trimethylhydroquinone, tetramethylhydroquinone, hydroxyhydroquinone, 3,5-dimethylbenzoquinone, tert-butylbenzoquinone, 4-butylresorcinol, 4-hexylresorcinol, 5-methylresorcinol, 5-pentylresorcinol, 2-propylresorcinol, 2,5-dimethylresorcinol, 2-methylresorcinol and 4-isopropylresorcinol, and

more preferably, at least one selected from the group consisting of p-toluquinone and 2-methylhydroquinone.

[43] In any one of [31] to [42], preferably, the quinone-based compound is used in an aqueous liquid comprising a quinone-based compound and a chelating agent in the following concentration:

preferably 1 ppm or more, more preferably 2 ppm or more, further preferably 3 ppm or more, further preferably 5 ppm or more, further preferably 7 ppm or more, further preferably 8 ppm or more, further preferably 9 ppm or more and further preferably 10 ppm or more; and preferably 1,400 ppm or less, more preferably 1,000 ppm or less, further preferably 500 ppm or less, further preferably 270 ppm or less, further preferably 200 ppm or less, further preferably 150 ppm or less, further preferably 100 ppm or less, further preferably 70 ppm or less, further preferably 60 ppm or less, further preferably 50 ppm or less, further preferably 40 ppm or less, further preferably 30 ppm or less, further preferably 20 ppm or less and further preferably 15 ppm or less; or

preferably from 1 to 1400 ppm, from 1 to 1000 ppm, from 1 to 500 ppm, from 1 to 270 ppm, from 1 to 200 ppm, from 1 to 150 ppm, from 1 to 100 ppm, from 1 to 70 ppm, from 1 to 60 ppm, from 1 to 50 ppm, from 1 to 40 ppm, from 1 to 30 ppm, from 1 to 20 ppm, from 1 to 15 ppm, from 2 to 1400 ppm, from 2 to 1000 ppm, from 2 to 500 ppm, from 2 to 270 ppm, from 2 to 200 ppm, from 2 to 150 ppm, from 2 to 100 ppm, from 2 to 70 ppm, from 2 to 60 ppm, from 2 to 50 ppm, from 2 to 40 ppm, from 2 to 30 ppm, from 2 to 20 ppm, from 2 to 15 ppm, from 3 to 1400 ppm, from 3 to 1000 ppm, from 3 to 500 ppm, from 3 to 270 ppm, from 3 to 200 ppm, from 3 to 150 ppm, from 3 to 100 ppm, from 3 to 70 ppm, from 3 to 60 ppm, from 3 to 50 ppm, from 3 to 40 ppm, from 3 to 30 ppm, from 3 to 20 ppm, from 3 to 15 ppm, from 5 to 1400 ppm, from 5 to 1000 ppm, from 5 to 500 ppm, from 5 to 270 ppm, from 5 to 200 ppm, from 5 to 150 ppm, from 5 to 100 ppm, from 5 to 70 ppm, from 5 to 60 ppm, from 5 to 50 ppm, from 5 to 40 ppm, from 5 to 30 ppm, from 5 to 20 ppm, from 5 to 15 ppm, from 7 to 1400 ppm, from 7 to 1000 ppm, from 7 to 500 ppm, from 7 to 270 ppm, from 7 to 200 ppm, from 7 to 150 ppm, from 7 to 100 ppm, from 7 to 70 ppm, from 7 to 60 ppm, from 7 to 50 ppm, from 7 to 40 ppm, from 7 to 30 ppm, from 7 to 20 ppm, from 7 to 15 ppm, from 8 to 1400 ppm, from 8 to 1000 ppm, from 8 to 500 ppm, from 8 to 270 ppm, from 8 to 200 ppm, from 8 to 150 ppm, from 8 to 100 ppm, from 8 to 70 ppm, from 8 to 60 ppm, from 8 to 50 ppm, from 8 to 40 ppm, from 8 to 30 ppm, from 8 to 20 ppm, from 8 to 15 ppm, from 9 to 1400 ppm, from 9 to 1000 ppm, from 9 to 500 ppm, from 9 to 270 ppm, from 9 to 200 ppm, from 9 to 150 ppm, from 9 to 100 ppm, from 9 to 70 ppm, from 9 to 60 ppm, from 9 to 50 ppm, from 9 to 40 ppm, from 9 to 30 ppm, from 9 to 20 ppm, from 9 to 15 ppm, from 10 to 1400 ppm, from 10 to 1000 ppm, from 10 to 500 ppm, from 10 to 270 ppm, from 10 to 200 ppm, from 10 to 150 ppm, from 10 to 100 ppm, from 10 to 70 ppm, from 10 to 60 ppm, from 10 to 50 ppm, from 10 to 40 ppm, from 10 to 30 ppm, from 10 to 20 ppm, or from 10 to 15 ppm.

[44] In any one of [31] to [43], preferably, the chelating agent is used in an aqueous liquid comprising a quinone-based compound and a chelating agent in the following concentration:

preferably 0.05 ppm or more, more preferably 0.1 ppm or more, further preferably 0.3 ppm or more, further preferably 0.5 ppm or more, further preferably 1 ppm or more and further preferably 2 ppm or more; and preferably 1000 ppm or less, more preferably 500 ppm or less, further preferably 100 ppm or less, further preferably 70 ppm or less, further preferably 50 ppm or less, further preferably 40 ppm or less, further preferably 30 ppm or less, further preferably 25 ppm or less and further preferably 20 ppm or less;

or,

preferably from 0.05 to 1000 ppm, from 0.05 to 500 ppm, from 0.05 to 100 ppm, from 0.05 to 70 ppm, from 0.05 to 50 ppm, from 0.05 to 40 ppm, from 0.05 to 30 ppm, from 0.05 to 25 ppm, from 0.05 to 20 ppm, from 0.1 to 1000 ppm, from 0.1 to 500 ppm, from 0.1 to 100 ppm, from 0.1 to 70 ppm, from 0.1 to 50 ppm, from 0.1 to 40 ppm, from 0.1 to 30 ppm, from 0.1 to 25 ppm, from 0.1 to 20 ppm, from 0.3 to 1000 ppm, from 0.3 to 500 ppm, from 0.3 to 100 ppm, from 0.3 to 70 ppm, from 0.3 to 50 ppm, from 0.3 to 40 ppm, from 0.3 to 30 ppm, from 0.3 to 25 ppm, from 0.3 to 20 ppm, from 0.5 to 1000 ppm, from 0.5 to 500 ppm, from 0.5 to 100 ppm, from 0.5 to 70 ppm, from 0.5 to 50 ppm, from 0.5 to 40 ppm, from 0.5 to 30 ppm, from 0.5 to 25 ppm, from 0.5 to 20 ppm, from 1 to 1000 ppm, from 1 to 500 ppm, from 1 to 100 ppm, from 1 to 70 ppm, from 1 to 50 ppm, from 1 to 40 ppm, from 1 to 30 ppm, from 1 to 25 ppm, from 1 to 20 ppm, from 2 to 1000 ppm, from 2 to 500 ppm, from 2 to 100 ppm, from 2 to 70 ppm, from 2 to 50 ppm, from 2 to 40 ppm, from 2 to 30 ppm, from 2 to 25 ppm, or from 2 to 20 ppm.

[45] In any one of [31] to [44], the concentrations of the quinone-based compound and the chelating agent in an aqueous liquid comprising a quinone-based compound and a chelating agent are preferably from 1 to 1400 ppm and from 0.05 to 1000 ppm; more preferably from 5 to 200 ppm and from 0.3 to 100 ppm; further preferably from 5 to 50 ppm and from 0.3 to 30 ppm; and further preferably from 5 to 30 ppm and from 0.5 to 20 ppm, respectively.
[46] In any one of [31] to [45], the amount of the chelating agent used relative to the quinone-based compound (100 parts by mass) is preferably 0.1 part by mass or more, more preferably 0.5 parts by mass or more, further preferably 1 part by mass or more, further preferably 3 parts by mass or more, further preferably 5 parts by mass or more and further preferably 7 parts by mass or more; and preferably 5000 parts by mass or less, more preferably 2000 parts by mass or less, further preferably 1000 parts by mass or less, further preferably 700 parts by mass or less, further preferably 500 parts by mass or less and further preferably 300 parts by mass or less;
or,

preferably, from 0.1 to 5000 parts by mass, from 0.1 to 2000 parts by mass, from 0.1 to 1000 parts by mass, from 0.1 to 700 parts by mass, from 0.1 to 500 parts by mass, from 0.1 to 300 parts by mass, from 0.5 to 5000 parts by mass, from 0.5 to 2000 parts by mass, from 0.5 to 1000 parts by mass, from 0.5 to 700 parts by mass, from 0.5 to 500 parts by mass, from 0.5 to 300 parts by mass, from 1 to 5000 parts by mass, from 1 to 2000 parts by mass, from 1 to 1000 parts by mass, from 1 to 700 parts by mass, from 1 to 500 parts by mass, from 1 to 300 parts by mass, from 3 to 5000 parts by mass, from 3 to 2000 parts by mass, from 3 to 1000 parts by mass, from 3 to 700 parts by mass, from 3 to 500 parts by mass, from 3 to 300 parts by mass, from 5 to 5000 parts by mass, from 5 to 2000 parts by mass, from 5 to 1000 parts by mass, from 5 to 700 parts by mass, from 5 to 500 parts by mass, from 5 to 300 parts by mass, from 7 to 5000 parts by mass, from 7 to 2000 parts by mass, from 75 to 1000 parts by mass, from 7 to 700 parts by mass, from 7 to 500 parts by mass, or from 7 to 300 parts by mass.

[47] In any one of [32] to [34] and [36] to [46], preferably, the aqueous liquid is cooling water of a water cooling tower.
[48] In any one of [31], [32] and [38] to [47], preferably, the biofilm formation inhibition composition is a biofilm formation inhibition composition for use in cooling water of a water cooling tower.
[49] In any one of [31], [32], [37] and [38] to [48], the content of a quinone-based compound in the biofilm formation inhibition composition is as follows:

preferably 0.1% by mass or more, more preferably 0.5% by mass or more, further preferably 1% by mass or more, further preferably 3% by mass or more and further preferably 5% by mass or more; and preferably 90% by mass or less, more preferably 70% by mass or less, further preferably 50% by mass or less, further preferably 30% by mass or less and further preferably 20% by mass or less;

or,

preferably from 0.1 to 90% by mass, from 0.1 to 70% by mass, from 0.1 to 50% by mass, from 0.1 to 30% by mass, from 0.1 to 20% by mass, from 0.5 to 90% by mass, from 0.5 to 70% by mass, from 0.5 to 50% by mass, from 0.5 to 30% by mass, from 0.5 to 20% by mass, from 1 to 90% by mass, from 1 to 70% by mass, from 1 to 50% by mass, from 1 to 30% by mass, from 1 to 20% by mass, from 3 to 90% by mass, from 3 to 70% by mass, from 3 to 50% by mass, from 3 to 30% by mass, from 3 to 20% by mass, from 5 to 90% by mass, from 5 to 70% by mass, from 5 to 50% by mass, from 5 to 30% by mass, or from 5 to 20% by mass.

[50] In any one of [31], [32], [37] and [38] to [49], the content of a chelating agent in the biofilm formation inhibition composition is as follows:

preferably 0.05% by mass or more, more preferably 0.1% by mass or more, further preferably 0.3% by mass or more and further preferably 0.5% by mass or more; and preferably 90% by mass or less, more preferably 70% by mass or less, further preferably 50% by mass or less, further preferably 30% by mass or less and further preferably 20% by mass or less;

or

preferably, from 0.05 to 90% by mass, from 0.05 to 70% by mass, from 0.05 to 50% by mass, from 0.05 to 30% by mass, from 0.05 to 20% by mass, from 0.1 to 90% by mass, from 0.1 to 70% by mass, from 0.1 to 50% by mass, from 0.1 to 30% by mass, from 0.1 to 20% by mass, from 0.3 to 90% by mass, from 0.3 to 70% by mass, from 0.3 to 50% by mass, from 0.3 to 30% by mass, from 0.3 to 20% by mass, from 0.5 to 90% by mass, from 0.5 to 70% by mass, from 0.5 to 50% by mass, from 0.5 to 30% by mass, or from 0.5 to 20% by mass.

[51] In any one of [31], [32], [37] and [38] to [50], the contents of the quinone-based compound and chelating agent in the biofilm formation inhibition composition are preferably from 0.1 to 90% by mass and from 0.05 to 90% by mass; more preferably from 1 to 50% by mass and from 0.1 to 50% by mass; further preferably from 1 to 20% by mass and from 0.3 to 30% by mass; further preferably from 3 to 20% by mass and from 0.3 to 30% by mass; and further preferably from 5 to 20% by mass and from 0.5 to 20% by mass, respectively.
[52] In any one of [31], [32], [37] and [38] to [51], the content of the chelating agent in the biofilm formation inhibition composition is as follows:

preferably 0.1 part by mass or more relative to the quinone-based compound (100 parts by mass), more preferably 0.5 parts by mass or more, further preferably 1 part by mass or more, further preferably 3 parts by mass or more, further preferably 5 parts by mass or more and further preferably 7 parts by mass or more; and preferably 5000 parts by mass or less; more preferably 2000 parts by mass or less, further preferably 1000 parts by mass or less, further preferably 700 parts by mass or less, further preferably 500 parts by mass or less and further preferably 300 parts by mass or less;

or,

preferably, from 0.1 to 5000 parts by mass, from 0.1 to 2000 parts by mass, from 0.1 to 1000 parts by mass, from 0.1 to 700 parts by mass, from 0.1 to 500 parts by mass, from 0.1 to 300 parts by mass, from 0.5 to 5000 parts by mass, from 0.5 to 2000 parts by mass, from 0.5 to 1000 parts by mass, from 0.5 to 700 parts by mass, from 0.5 to 500 parts by mass, from 0.5 to 300 parts by mass, from 1 to 5000 parts by mass, from 1 to 2000 parts by mass, from 1 to 1000 parts by mass, from 1 to 700 parts by mass, from 1 to 500 parts by mass, from 1 to 300 parts by mass, from 3 to 5000 parts by mass, from 3 to 2000 parts by mass, from 3 to 1000 parts by mass, from 3 to 700 parts by mass, from 3 to 500 parts by mass, from 3 to 300 parts by mass, from 5 to 5000 parts by mass, from 5 to 2000 parts by mass, from 5 to 1000 parts by mass, from 5 to 700 parts by mass, from 5 to 500 parts by mass, from 5 to 300 parts by mass, from 7 to 5000 parts by mass, from 7 to 2000 parts by mass, from 7 to 1000 parts by mass, from 7 to 700 parts by mass, from 7 to 500 parts by mass, or from 7 to 300 parts by mass.

[53] In any one of [31], [32], [37] and [38] to [52], the biofilm formation inhibition composition may comprise an organic solvent as an optional component and

the amount of the organic solvent in the composition is

preferably 95% by mass or less and more preferably 93% by mass or less; and preferably 0% by mass or more, more preferably 30% by mass or more, further preferably 50% by mass or more and further preferably 70% by mass or more; or

preferably, from 0 to 95% by mass, from 0 to 93% by mass, from 30 to 95% by mass, from 30 to 93% by mass, from 50 to 95% by mass, from 50 to 93% by mass, from 70 to 95% by mass or from 70 to 93% by mass.

[54] A biofilm formation inhibition composition comprising a quinone-based compound and an organic solvent.
[55] The composition according to [54], preferably used in inhibition of biofilm formation in an aqueous liquid or an aqueous system using an aqueous liquid.
[56] The composition according to [54] or [55], in which the quinone-based compound is preferably at least one selected from the group consisting of a hydroquinone substituted by a hydroxyl group or an alkyl group, a p-benzoquinone substituted by a hydroxyl group or an alkyl group and a C1 to C5 alkyl resorcinol.
[57] The composition according to [54] or [55], in which the quinone-based compound is

preferably, a compound having a single benzene ring having two or three ketone groups,

the ketone groups may be reduced into hydroxyl groups, further one of the hydroxyl groups may be alkoxylated,

the benzene ring is substituted by one to three alkyl groups or preferably a single alkyl group, and

the alkyl groups each independently represent preferably a linear or branched alkyl group having 1 or more and 12 or less carbon atoms, more preferably 1 or more and 8 or less carbon atoms, further preferably 1 or more and 6 or less carbon atoms and further preferably 1 or more and 3 or less carbon atoms; or still preferably an alkyl group selected from the group consisting of a methyl group, an ethyl group, a propyl group, an isopropyl group, a butyl group, a t-butyl group, a pentyl group, a hexyl group, a heptyl group, an octyl group and a 2-ethylhexyl group.

[58] The composition according to [54] or [55], in which the quinone-based compound is preferably at least one selected from the group consisting of the compounds represented by formulas (I), (II) and (IV):

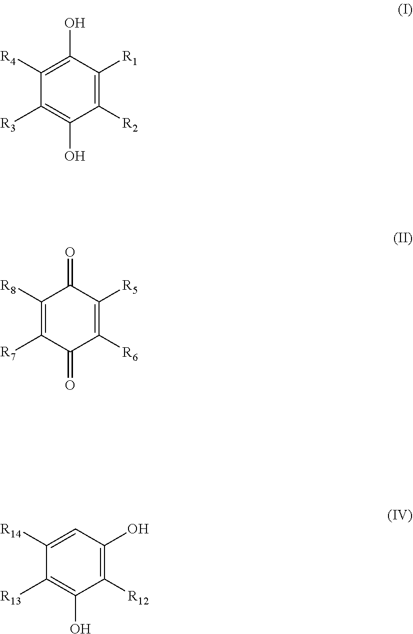

In formula (I),

R₁ represents a hydroxyl group or a linear or branched alkyl group having from 1 to 4 carbon atoms, and

R₂, R₃ and R₄ each independently represent hydrogen or a methyl group, and

more preferably,

R₁ is a hydroxyl group or a linear or branched alkyl group having from 1 to 4 carbon atoms and R₂, R₃ and R₄ all represent hydrogen, or

R₁ represents a methyl group, R₃ represents hydrogen and one of R₃ and R₄ represents a methyl group and the other represents hydrogen or both of R₂ and R₄ represent a methyl group, or,

R₁, R₂, R₃ and R₄ all represent a methyl group.

In formula (II),

R₅ represents a hydroxyl group or a linear or branched alkyl group having from 1 to 4 carbon atoms, and

R₆, R₇, and R₈ each independently represent hydrogen or a methyl group; and

more preferably, R₅ represents a linear or branched alkyl group having from 1 to 4 carbon atoms and R₆, R₇ and R₈ all represent hydrogen.

In formula (IV),

R₁₂, R₁₃ and R₁₄ each independently represent hydrogen or a linear or branched alkyl group having from 1 to 8 carbon atoms (provided that R₁₂, R₁₃ and R₁₄ do not simultaneously represent hydrogen);

more preferably, any one of R₁₂, R₁₃ and R₁₄ represents a linear or branched alkyl group having from 1 to 6 carbon atoms and the others both represent hydrogen, or any two of R₁₂, R₁₃ and R₁₄ represent a linear alkyl group having from 1 to 6 carbon atoms and the other represents hydrogen; and

further preferably, R₁₂, R₁₃ and R₁₄ each independently represent hydrogen or a linear or branched alkyl group having from 1 to 5 carbon atoms (provided that R₁₂, R₁₃ and R₁₄ do not simultaneously represent hydrogen).

[59] The composition according to [54] or [55], in which the quinone-based compound is

preferably, at least one selected from the group consisting of p-toluquinone, 2-methylhydroquinone, ethylquinol, 2-butylhydroquinone, tert-butylhydroquinone, 2,6-dimethylhydroquinone, 2,3-dimethylhydroquinone, 2,3,5-trimethylhydroquinone, tetramethylhydroquinone, hydroxyhydroquinone, 3,5-dimethylbenzoquinone, tert-butylbenzoquinone, 4-butylresorcinol, 4-hexylresorcinol, 5-methylresorcinol, 5-pentylresorcinol, 2-propylresorcinol, 2,5-dimethylresorcinol, 2-methylresorcinol and 4-isopropylresorcinol, and

more preferably, at least one selected from the group consisting of p-toluquinone, 2-methylhydroquinone and an alkyl resorcinol (herein, the alkyl resorcinol may be selected from tert-butylbenzoquinone, 4-butylresorcinol, 4-hexylresorcinol, 5-methylresorcinol, 5-pentylresorcinol, 2-propylresorcinol, 2,5-dimethylresorcinol, 2-methylresorcinol and 4-isopropylresorcinol).

[60] The composition according to any one of [54] to [59], in which C log P of the organic solvent is preferably −3 or more, more preferably −2.5 or more and further preferably −2 or more; and preferably 4 or less, more preferably 3.5 or less, further preferably 3 or less; or preferably from −3 to 4, from −3 to 3.5, from −3 to 3, from −2.5 to 4, from −2.5 to 3.5, from −2.5 to 3, from −2 to 4, from −2 to 3.5 or from −2 to 3.
[61] The composition according to any one of [54] to [60], in which the organic solvent is preferably an alcohol-based organic solvent or an ether-based organic solvent, more preferably, an aliphatic alcohol-based organic solvent or an aliphatic ether-based organic solvent, and further preferably a glycol-based organic solvent.
[62] The composition according to any one of [54] to [61], in which the organic solvent is preferably a mono- or polyalkylene glycol monoalkyl ether;

the alkylene glycol herein is ethylene glycol, propylene glycol or butylene glycol;

the “poly” represents polymerization of two or more and three or less of alkylene glycols;

an alkyl group of the alkyl ether is an alkyl group having preferably one or more; and preferably 8 or less carbon atoms, more preferably 6 or less, further preferably 4 or less, further preferably 2 or less; or an alkyl group having from 1 to 8, from 1 to 6, from 1 to 4 or from 1 to 2 carbon atoms.

[63] The composition according to [54] to [62], in which the number of carbon atoms of the organic solvent is preferably 3 or more and more preferably 4 or more; and preferably 12 or less, more preferably 8 or less and further preferably 6 or less; or preferably from 3 to 12, from 3 to 8, from 3 to 6, from 4 to 12, from 4 to 8 or from 4 to 6.
[64] The composition according to any one of [54] to [63], in which the organic solvent is

preferably at least one selected from the group consisting of ethylene glycol mono(2-ethylhexyl) ether, 1-phenoxy-2-propanol, 2-phenoxyethanol, 1-butoxy-2-propanol, ethylene glycol monobutyl ether, 2-isobutoxy ethanol, 2-(2-n-butoxyethoxy)ethanol, propylene glycol, 2-(2-isobutoxyethoxy)ethanol), triethylene glycol monobutyl ether, diacetone alcohol, 2-ethoxyethanol, 1-methoxy-2-p-propanol, dipropylene glycol, 2-(2-ethoxyethoxy) ethanol, 2-methoxyethanol, diethylene glycol monomethyl ether, diethylene glycol, triethylene glycol monomethyl ether and diethylene glycol monomethyl ether, and

more preferably, dipropylene glycol, diethylene glycol, diacetone alcohol, diethylene glycol monomethyl ether and propylene glycol.

[65] The composition according to any one of [54] to [64], in which the content of the quinone-based compound is

preferably 0.1% by mass or more, more preferably 0.5% by mass or more, further preferably 1% by mass or more, further preferably 3% by mass or more and further preferably 5% by mass or more; and preferably 90% by mass or less, more preferably 70% by mass or less, further preferably 50% by mass or less, further preferably 30% by mass or less and further preferably 20% by mass or less; or,

preferably, from 0.1 to 90% by mass, from 0.1 to 70% by mass, from 0.1 to 50% by mass, from 0.1 to 30% by mass, from 0.1 to 20% by mass, from 0.5 to 90% by mass, from 0.5 to 70% by mass, from 0.5 to 50% by mass, from 0.5 to 30% by mass, from 0.5 to 20% by mass, from 1 to 90% by mass, from 1 to 70% by mass, from 1 to 50 t by mass, from 1 to 30% by mass, from 1 to 20% by mass, from 3 to 90 s by mass, from 3 to 70% by mass, from 3 to 50% by mass, from 3 to 30% by mass, from 3 to 20% by mass, from 5 to 90% by mass, from 5 to 70% by mass, from 5 to 50% by mass, from 5 to 30% by mass, or from 5 to 20% by mass.

[66] The composition according to any one of [54] to [65], in which the content of the organic solvent is

preferably 10% by mass or more, more preferably 30% by mass or more, further preferably 50% by mass or more, further preferably 60% by mass or more, further preferably 70% by mass or more, further preferably 80% by mass or more and further preferably 90% by mass or more; and preferably 99.9% by mass or less, more preferably 99.5% by mass or less, further preferably 99% by mass or less, further preferably 97% by mass or less, further preferably 95% by mass or less;

or,

preferably, from 10 to 99.9% by mass, from 10 to 99.5% by mass, from 10 to 99% by mass, from 10 to 97% by mass, from 10 to 95% by mass, from 30 to 99.9% by mass, from 30 to 99.5% by mass, from 30 to 99% by mass, from 30 to 97 s by mass, from 30 to 95% by mass, from 50 to 99.9% by mass, from 50 to 99.5% by mass, from 50 to 99% by mass, from 50 to 97% by mass, from 50 to 95% by mass, from 60 to 99.9% by mass, from 60 to 99.5% by mass, from 60 to 99% by mass, from 60 to 97% by mass, from 60 to 95% by mass, from 70 to 99.9% by mass, from 70 to 99.5% by mass, from 70 to 99% by mass, from 70 to 97% by mass, from 70 to 95% by mass, from 80 to 99.9% by mass, from 80 to 99.5% by mass, from 80 to 99% by mass, from 80 to 97% by mass, from 80 to 95% by mass, from 90 to 99.9% by mass, from 90 to 99.5% by mass, from 90 to 99% by mass, from 90 to 97% by mass, or from 90 to 95% by mass.

[67] The composition according to any one of [54] to [66], in which the contents of the quinone-based compound and organic solvent are preferably from 0.1 to 90% by mass and from 10 to 99.9% by mass; more preferably from 1 to 50% by mass and from 50 to 99.5% by mass; further preferably from 1 to 30% by mass and from 70 to 99% by mass; further preferably from 1 to 20% by mass and from 80 to 95% by mass; and further preferably from 5 to 20% by mass and from 80 to 95% by mass, respectively.
[68] The composition according to any one of [54] to [67], in which the mass ratio of the organic solvent to the quinone-based compound is

preferably 500 or less, more preferably 200 or less, further preferably 150 or less, further preferably 100 or less, further preferably 50 or less and further preferably 20 or less; and preferably 0.1 or more, more preferably 0.5 or more, further preferably one or more, further preferably 2 or more and further preferably 3 or more;

or,

preferably, from 0.1 to 500, from 0.1 to 200, from 0.1 to 150, from 0.1 to 100, from 0.1 to 50, from 0.1 to 20, from 0.5 to 500, from 0.5 to 200, from 0.5 to 150, from 0.5 to 100, from 0.5 to 50, from 0.5 to 20, from 1 to 500, from 1 to 200, from 1 to 150, from 1 to 100, from 1 to 50, from 1 to 20, from 2 to 500, from 2 to 200, from 2 to 150, from 2 to 100, from 2 to 50, from 2 to 20, from 3 to 500, from 3 to 200, from 3 to 150, from 3 to 100, from 3 to 50, or from 3 to 20.

[69] The composition according to any one of [54] to [68], in which the total content of the quinone-based compound and the organic solvent is preferably 50% by mass or more, more preferably 70% by mass or more, further preferably 80% by mass or more, further preferably 85 t by mass or more, further preferably 90% by mass or more, further preferably 95% by mass or more, further preferably 99% by mass or more and preferably 100% by mass or less.
[70] The composition according to any one of [54] to [69], in which water may be contained as an optional component and the content of water is preferably 50% by mass or less, more preferably 30% by mass or less, further preferably 10% by mass or less, further preferably 5% by mass or less, further preferably 1% by mass or less and preferably 0% by mass or more.
[71] The composition according to any one of [54] to [70], preferably being biofilm formation inhibition composition for use in cooling water of a water cooling tower.
[72] A method for inhibiting biofilm formation comprising adding a biofilm formation inhibition composition comprising a quinone-based compound and an organic solvent according to any one of [54] to [71], in an aqueous liquid.
[73] The method according to [72], in which preferably, formation of a biofilm in an aqueous system using the aqueous liquid or the aqueous liquid, is inhibited.
[74] The method according to [72] or [73], in which the biofilm formation inhibition composition is added in an aqueous liquid comprising a quinone-based compound and an organic solvent such that the concentration of the quinone-based compound in the aqueous liquid becomes as follows:

preferably 1 ppm or more, more preferably 2 ppm or more, further preferably 3 ppm or more, further preferably 5 ppm or more, further preferably 7 ppm or more, further preferably 8 ppm or more, further preferably 9 ppm or more and further preferably 10 ppm or more; and preferably 1400 ppm or less, more preferably 1000 ppm or less, further preferably 500 ppm or less, further preferably 270 ppm or less, further preferably 200 ppm or less, further preferably 150 ppm or less, further preferably 100 ppm or less, further preferably 70 ppm or less, further preferably 60 ppm or less, further preferably 50 ppm or less, further preferably 40 ppm or less, further preferably 30 ppm or less, further preferably 20 ppm or less and further preferably 15 ppm or less;

or,

preferably, from 1 to 1400 ppm, from 1 to 1000 ppm, from 1 to 500 ppm, from 1 to 270 ppm, from 1 to 200 ppm, from 1 to 150 ppm, from 1 to 100 ppm, from 1 to 70 ppm, from 1 to 60 ppm, from 1 to 50 ppm, from 1 to 40 ppm, from 1 to 30 ppm, from 1 to 20 ppm, from 1 to 15 ppm, from 2 to 1400 ppm, from 2 to 1000 ppm, from 2 to 500 ppm, from 2 to 270 ppm, from 2 to 200 ppm, from 2 to 150 ppm, from 2 to 100 ppm, from 2 to 70 ppm, from 2 to 60 ppm, from 2 to 50 ppm, from 2 to 40 ppm, from 2 to 30 ppm, from 2 to 20 ppm, from 2 to 15 ppm, from 3 to 1400 ppm, from 3 to 1000 ppm, from 3 to 500 ppm, from 3 to 270 ppm, from 3 to 200 ppm, from 3 to 150 ppm, from 3 to 100 ppm, from 3 to 70 ppm, from 3 to 60 ppm, from 3 to 50 ppm, from 3 to 40 ppm, from 3 to 30 ppm, from 3 to 20 ppm, from 3 to 15 ppm, from 5 to 1400 ppm, from 5 to 1000 ppm, from 5 to 500 ppm, from 5 to 270 ppm, from 5 to 200 ppm, from 5 to 150 ppm, from 5 to 100 ppm, from 5 to 70 ppm, from 5 to 60 ppm, from 5 to 50 ppm, from 5 to 40 ppm, from 5 to 30 ppm, from 5 to 20 ppm, from 5 to 15 ppm, from 7 to 1400 ppm, from 7 to 1000 ppm, from 7 to 500 ppm, from 7 to 270 ppm, from 7 to 200 ppm, from 7 to 150 ppm, from 7 to 100 ppm, from 7 to 70 ppm, from 7 to 60 ppm, from 7 to 50 ppm, from 7 to 40 ppm, from 7 to 30 ppm, from 7 to 20 ppm, from 7 to 15 ppm, from 8 to 1400 ppm, from 8 to 1000 ppm, from 8 to 500 ppm, from 8 to 270 ppm, from 8 to 200 ppm, from 8 to 150 ppm, from 8 to 100 ppm, from 8 to 70 ppm, from 8 to 60 ppm, from 8 to 50 ppm, from 8 to 40 ppm, from 8 to 30 ppm, from 8 to 20 ppm, from 8 to 15 ppm, from 9 to 1400 ppm, from 9 to 1000 ppm, from 9 to 500 ppm, from 9 to 270 ppm, from 9 to 200 ppm, from 9 to 150 ppm, from 9 to 100 ppm, from 9 to 70 ppm, from 9 to 60 ppm, from 9 to 50 ppm, from 9 to 40 ppm, from 9 to 30 ppm, from 9 to 20 ppm, from 9 to 15 ppm, from 10 to 1400 ppm, from 10 to 1000 ppm, from 10 to 500 ppm, from 10 to 270 ppm, from 10 to 200 ppm, from 10 to 150 ppm, from 10 to 100 ppm, from 10 to 70 ppm, from 10 to 60 ppm, from 10 to 50 ppm, from 10 to 40 ppm, from 10 to 30 ppm, from 10 to 20 ppm, or from 10 to 15 ppm.

[75] The method according to any one of [72] to [74], in which the biofilm formation inhibition composition is added in an aqueous liquid comprising a quinone-based compound and an organic solvent such that the concentration of the organic solvent in the aqueous liquid becomes as follows:

preferably 0.5% by mass or less, more preferably 0.2% by mass or less, further preferably 0.1% by mass or less, further preferably 0.05% by mass or less, further preferably 0.01% by mass or less; and preferably 0.00001% by mass or more.

[76] The method according to any one of [72] to [75], in which, the biofilm formation inhibition composition is added in an aqueous liquid comprising a quinone-based compound and an organic solvent such that the concentrations of the quinone-based compound and organic solvent in the aqueous liquid become as follows:

preferably from 1 to 1400 ppm and from 0.1 to 5000 ppm; more preferably from 5 to 200 ppm and from 0.1 to 2000 ppm; further preferably from 5 to 50 ppm and from 0.1 to 1000 ppm; and further preferably from 5 to 30 ppm and from 0.1 to 500 ppm, respectively.

[77] The method according to any one of [72] to [76], in which, the biofilm formation inhibition composition is added in an aqueous liquid comprising a quinone-based compound and an organic solvent such that the mass ratio of the organic solvent relative to the quinone-based compound in the aqueous liquid becomes as follows:

preferably 500 or less, more preferably 200 or less, further preferably 150 or less, further preferably 100 or less, further preferably 50 or less and further preferably 20 or less; and preferably 0.1 or more, more preferably 0.5 or more, further preferably one or more, further preferably 2 or more and further preferably 3 or more;

or,

preferably, from 0.1 to 500, from 0.1 to 200, from 0.1 to 150, from 0.1 to 100, from 0.1 to 50, from 0.1 to 20, from 0.5 to 500, from 0.5 to 200, from 0.5 to 150, from 0.5 to 100, from 0.5 to 50, from 0.5 to 20, from 1 to 500, from 1 to 200, from 1 to 150, from 1 to 100, from 1 to 50, from 1 to 20, from 2 to 500, from 2 to 200, from 2 to 150, from 2 to 100, from 2 to 50, from 2 to 20, from 3 to 500, from 3 to 200, from 3 to 150, from 3 to 100, from 3 to 50, or from 3 to 20.

[78] The method according to any one of [72] to [77], in which, the aqueous liquid is cooling water of a water cooling tower.
[79] Use of the biofilm formation inhibition composition comprising a quinone-based compound and an organic solvent according to any one of [54] to [71], for inhibiting biofilm formation.
[80] Use according to [79], in which the use is preferably use for inhibiting biofilm formation in an aqueous liquid or an aqueous system using an aqueous liquid.
[81] Use according to [80], in which the aqueous liquid is cooling water in a water cooling tower.

### EXAMPLES

Now, the present invention will be more specifically described based on Examples; however, the present invention is not limited to these.

### Test Example 1 Measurement of Biofilm Formation Inhibitory Activity

### 1) Preparation of Test Microbe

Pseudomonas PAO1 strain (ATCC 15692) was subjected to stationary culture performed in LB culture medium (Lysogeny Broth; manufactured by Becton Dickinson) at 37° C. for 24 hours. The turbidity (OD600) of the culture solution was measured. The culture solution was diluted with Mueller Hinton Broth (BBL made) to prepare a suspension (15 mL) having a turbidity (OD600) of 1/10⁶.

### 2) Culture

To each of the wells of a 96-well microplate (351172; manufactured by Japan Becton Dickinson), 6 μL of DMSO (Tokyo Chemical Industry Co. Ltd) and an ethanol solution (1 μL, 3 μL or 5 μL) of a test compound were added. After that, the microplate was allowed to stand still at room temperature for 5 hours to evaporate ethanol. The suspension of Pseudomonas microbe prepared in the above step 1) was added in an amount of 145 μL per well and culture was initiated. As the test compound, 2-methylhydroquinone (Sigma Aldrich) and p-toluquinone (Tokyo Kasei) were used. As a reference compound, sodium hypochlorite (manufactured by Wako Pure Chemical Industries Ltd.) was used. As a control, an ethanol solvent (EtOH control) alone was used. The concentration of the test compound in the ethanol solution is 1,000 ppm or 10,000 ppm and the final concentration of the test compound in the culture solution was about from 7 to 333 ppm.

### 3) Measurement

After the 96-well microplate was subjected to stationary culture performed at 30° C. for 24 hours, turbidity (OD600) was measured to check growth. Subsequently, individual wells were stained with 0.1% crystal violet and thoroughly washed twice with physiological saline. To each well, 200 μL of ethanol was added and the absorbance (OD570) was measured to obtain the amount of the biofilm formed.

### 4) Results

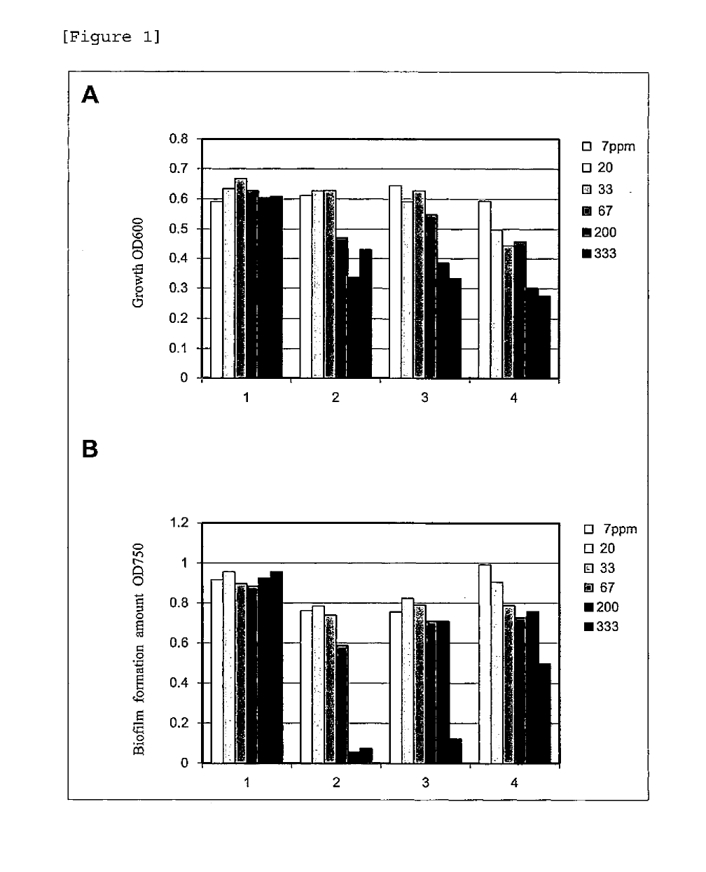

The amounts of growth (OD600) of a test microbe are shown in Table 1 and the amounts of biofilm formed (OD570) are shown in Table 2. These results are also shown in FIG. 1. Sodium hypochlorite inhibited not only microbial growth but also biofilm formation. From this, it was estimated that biofilm formation was inhibited as a result that the microbe was killed. In contrast, 2-methylhydroquinone and p-toluquinone inhibited not only microbial growth but also biofilm formation in a high concentration range of 200 ppm or more. In contrast, biofilm formation was inhibited in a low concentration range of less than 200 ppm; however, the biofilm formation inhibitory effect which did not correspond with microbial growth inhibitory effect was observed. Accordingly, it was demonstrated that 2-methylhydroquinone and p-toluquinone had an effect to inhibit biofilm formation which does not rely on bactericidal or antimicrobial effect.

TABLE 1
Growth OD600

| Final | | | | Sodium |
|---|---|---|---|---|
| concentration | EtOH | Methyl- | p- | hypochlorite |
| (ppm) | (Control) | hydroquinone | Toluquinone | (reference) |
| 7 | 0.5913 | 0.6114 | 0.645 | 0.5938 |
| 20 | 0.6346 | 0.6276 | 0.5907 | 0.4966 |
| 33 | 0.668 | 0.6291 | 0.6284 | 0.4445 |
| 67 | 0.628 | 0.471 | 0.5489 | 0.4585 |
| 200 | 0.6045 | 0.3373 | 0.3857 | 0.3016 |
| 333 | 0.6088 | 0.4302 | 0.3334 | 0.2758 |

TABLE 2
The amount of the biofilm formed OD570

| Final | | | | Sodium |
|---|---|---|---|---|
| concentration | EtOH | Methyl- | p- | hypochlorite |
| (ppm) | (Control) | hydroquinone | Toluquinone | (reference) |
| 7 | 0.9163 | 0.7615 | 0.7549 | 0.9918 |
| 20 | 0.9564 | 0.7848 | 0.8231 | 0.9042 |
| 33 | 0.8974 | 0.739 | 0.7891 | 0.7879 |
| 67 | 0.8853 | 0.5875 | 0.7094 | 0.7277 |
| 200 | 0.9248 | 0.0566 | 0.7089 | 0.7579 |
| 333 | 0.9562 | 0.0744 | 0.1222 | 0.4967 |

### Test Example 2 Measurement of Biofilm Formation Inhibitory Activity

### 1) Culture and Measurement

Compounds listed in Table 3 were each added to a test microbe and culture was conducted by the same procedure as in Test Example 1 and the amount of growth (OD600) and the amount of biofilm formed (OD570) were measured. For compounds a, b, c, f, h, i, J and k, 20 mM ethanol solutions were prepared; whereas for compounds d, e, g, 5 mM ethanol solutions were prepared. The solutions were each added to a 96-well microplate in an amount of 1 to 8 μL and evaluation was made. The final concentrations of the individual compounds are described in Table 3.

TABLE 3

| | | | | Final |
|---|---|---|---|---|
| | | | | concen- |
| | | | | tration |
| Compound | | CAS No. | Manufacturer | (ppm) |
| a | p-Toluquinone | 553-97-9 | Tokyo Kasei | 17-132 |
| b | 2-Methylhydroquinone | 95-71-6 | Sigma Aldrich | 16-130 |
| c | tert-Butylhydroquinone | 1948-33-0 | Wako Pure | 22-177 |
| | | | Chemical | |
| d | 2,6-Dimethylhydroquinone | 654-42-2 | Wako Pure | 5-37 |
| | | | Chemical | |
| e | 2,3-Dimethylhydroquinone | 608-43-5 | Wako Pure | 5-37 |
| | | | Chemical | |
| f | Ethylquinol | 2349-70-4 | ChromoDex | 18-147 |
| g | 2,3,5-Trimethylhydroquinone | 700-13-0 | Wako Pure | 5-41 |
| | | | Chemical | |
| h | Hydroxyhydroquinone | 533-73-3 | Wako Pure | 17-134 |
| | | | Chemical | |
| i | 3,5-Dimethylbenzoquinone | 527-61-7 | Sigma Aldrich | 18-145 |
| j | 2-Butylhydroquinone | 4197-69-7 | Sinova | 22-177 |
| k | tert-Butylbenzoquinone | 3602-55-9 | ChromoDex | 22-175 |

Growth inhibition rates relative to the control (ethanol alone) were calculated based on OD600 values measured and in accordance with the following expression. In addition, biofilm (BF) formation inhibition rates relative to the control (ethanol alone) were calculated based on OD570 values and in accordance with the following expression:

Growth inhibition (%)=(1−(compound addition group OD600/control group OD600))×100

BF inhibition (%)={1−(compound addition group OD570/control group OD570)}×100

### 2) Results

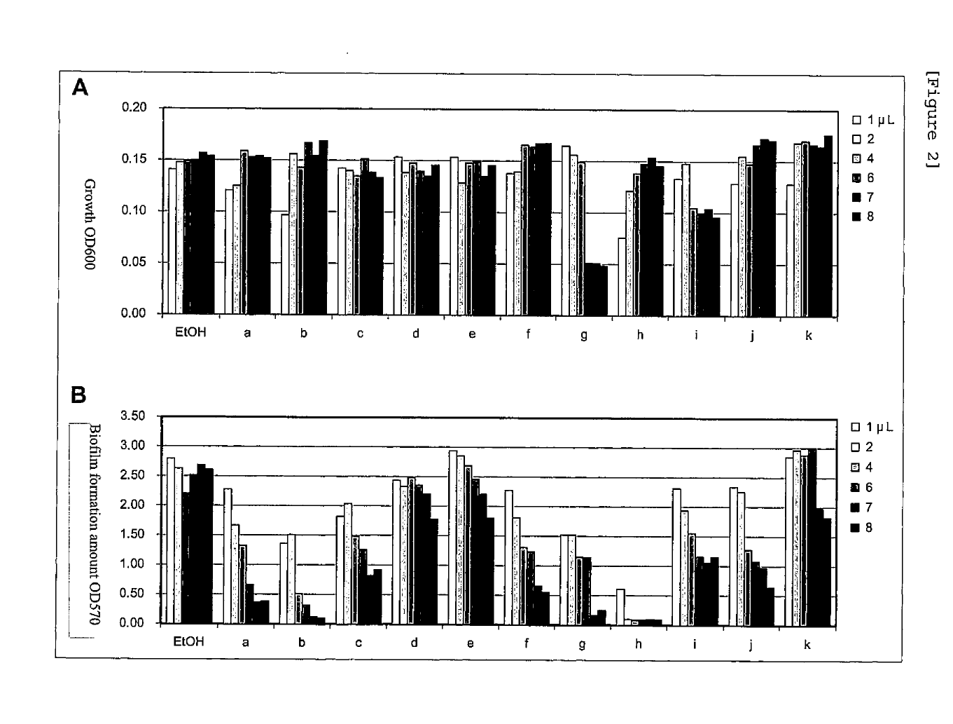

The amounts of growth (OD600) and the amounts of biofilms formed (OD570) are shown in FIG. 2; whereas growth inhibition (%) and BF inhibition (%) are shown in Table 4. In Table 4, a case where growth inhibition rate or BF inhibition rate is 0 or less is indicated by “not inhibited”. The compounds listed in Table 3 had a tendency to exhibit higher BP inhibition rates particularly within a low concentration range than the microbe growth inhibition rates. The compounds listed in Table 3 also showed biofilm formation inhibitory effects at a concentration where no antimicrobial effect was exhibited (a microbe growth inhibition rate: 20% or less). Accordingly, it was demonstrated that the compounds listed in Table 3 have an effect to inhibit formation of a biofilm (more specifically, non-antimicrobial biofilm formation inhibitory effect) not relying on germicidal or antimicrobial effect.

TABLE 4

| Amount of | | | | | | | | | |
|---|---|---|---|---|---|---|---|---|---|
| compound | Final | BF | Growth | Final | BF | Growth | Final | BF | Growth |
| solution | concentration | inhibition | inhibition | concentration | inhibition | inhibition | concentration | inhibition | inhibition |
| added (μL) | (ppm) | (%) | (%) | (ppm) | (%) | (%) | (ppm) | (%) | (%) |
| | a: p-Toluquinone | | | b: 2-Methylhydroquinone | | | c: tert-Butylhydroquinone | | |
| 1 | 17 | 18.6 | 14.2 | 16 | 51.4 | 31.2 | 22 | 34.8 | — |
| 2 | 33 | 36.6 | 15.4 | 33 | 42.5 | — | 44 | 22.5 | 5.3 |
| 4 | 66 | 39.9 | — | 65 | 76.5 | 4.0 | 89 | 32.5 | 9.5 |
| 6 | 99 | 73.7 | — | 98 | 87.3 | — | 133 | 50.0 | — |
| 7 | 116 | 86.3 | 1.8 | 114 | 95.2 | 1.5 | 155 | 69.3 | 11.8 |
| 8 | 132 | 85.1 | 1.2 | 130 | 96.2 | 0.0 | 177 | 64.8 | 13.3 |
| | d: 2,6-Dimethylhydroquinone | | | e: 2,3-Dimethylhydroquinone | | | f: Ethylquinol | | |
| 1 | 5 | 12.7 | — | 5 | — | — | 18 | 18.6 | 2.1 |
| 2 | 9 | 11.2 | 6.3 | 9 | — | 13.1 | 37 | 31.1 | 5.5 |
| 4 | 18 | — | 0.8 | 18 | — | 0.8 | 74 | 40.6 | — |
| 6 | 27 | 6.3 | 6.6 | 27 | 2.4 | — | 110 | 50.8 | — |
| 7 | 32 | 17.8 | 14.0 | 32 | 17.8 | 14.0 | 129 | 75.4 | — |
| 8 | 37 | 31.9 | 5.4 | 37 | 31.1 | 5.4 | 147 | 78.9 | — |
| | g: 2,3,5-Trimethylhydroquinone | | | h: Hydroxyhydroquinone | | | i: 3,5-Dimethylbenzoquinone | | |
| 1 | 5 | 45.5 | — | 17 | 78.2 | 46.2 | 18 | 17.2 | 5.3 |
| 2 | 10 | 42.2 | — | 34 | 96.2 | 18.0 | 36 | 26.2 | — |
| 4 | 20 | 48.0 | 0.1 | 67 | 96.1 | 7.2 | 72 | 29.4 | 29.7 |
| 6 | 30 | 54.7 | 65.8 | 101 | 96.3 | 1.7 | 109 | 54.0 | 33.5 |
| 7 | 35 | 93.9 | 67.5 | 118 | 96.3 | 2.0 | 127 | 60.9 | 33.7 |
| 8 | 41 | 90.4 | 68.5 | 134 | 96.4 | 5.4 | 145 | 55.8 | 37.7 |

| Amount of | j: 2-Butylhydroquinone | | | k: tert-Butylbenzoquinone | | |
|---|---|---|---|---|---|---|
| compound | Final | BF | Growth | Final | BF | Growth |
| solution | concentration | inhibition | inhibition | concentration | inhibition | inhibition |
| added (μL) | (ppm) | (%) | (%) | (ppm) | (%) | (%) |
| 1 | 22 | 16.3 | 8.5 | 22 | — | 8.9 |
| 2 | 44 | 14.1 | — | 44 | — | — |
| 4 | 89 | 42.1 | 0.8 | 88 | — | — |
| 6 | 133 | 57.3 | — | 131 | — | — |
| 7 | 155 | 63.9 | — | 154 | 26.2 | — |
| 8 | 177 | 75.4 | — | 175 | 30.3 | — |

—: No growth inhibition or no BF inhibition

### Test Example 3 Measurement of Biofilm Formation Inhibitory Activity

### 1) Culture

Ethanol solutions of the test compounds listed in Table 5 were prepared. As a control, an ethanol solvent alone was used (EtOH control). The concentrations of test compounds in the ethanol solution were as follows: test compound 1: 20 mM, test compounds 2 to 7: 100 mM. To each of the wells of a 96-well microplate (351172; manufactured by Japan Becton Dickinson), 6 μL of DMSO (Tokyo Kasei) and an ethanol solution of each test compound (1 to 8 μL) were added and then the microplates were allowed to stand still at room temperature for 5 hours to evaporate ethanol. A suspension solution of a Pseudomonas microbe prepared in the same procedure as in Test Example 1, 1) was added in an amount of 145 μL per well and culture was initiated.

TABLE 5

| | | | | Final |
|---|---|---|---|---|
| | | | | concen- |
| | | | | tration |
| Compound | | CAS No. | Manufacturer | (ppm) |
| 1 | 4-Butylresorcinol | 18979-61-8 | Tokyo Kasei | 22-177 |
| 2 | 5-Methylresocinol | 504-15-4 | Fluorochem | 82-661 |
| 3 | 5-Pentylresorcinol | 500-66-3 | Combi-Blocks | 120-960 |
| 4 | 2-Propylresorcinol | 13331-19-6 | Wako Pure | 101-811 |
| | | | Chemical | |
| 5 | 2,5-Dimethylresorcinol | 488-87-9 | Sigma Aldrich | 92-736 |
| 6 | 2-Methylresorcinol | 608-25-3 | Fluorochem | 83-661 |
| 7 | 4-Isopropylresorcinol | 23504-03-2 | Fluorochem | 101-811 |

### 2) Measurement

After the 96-well microplate was subjected to stationary culture at 30° C. for 24 hours, turbidity (OD600) was measured to check growth. Subsequently, individual wells were stained with 0.1% crystal violet and thoroughly washed twice with physiological saline. To each well, 200 μL of ethanol was added and the absorbance (OD570) was measured to obtain the amount of the biofilm formed. The growth inhibition rate and biofilm (BF) formation inhibition rate were calculated based on OD600 and OD570 values measured and in accordance with the expressions used in Test Example 2.

### 3) Results

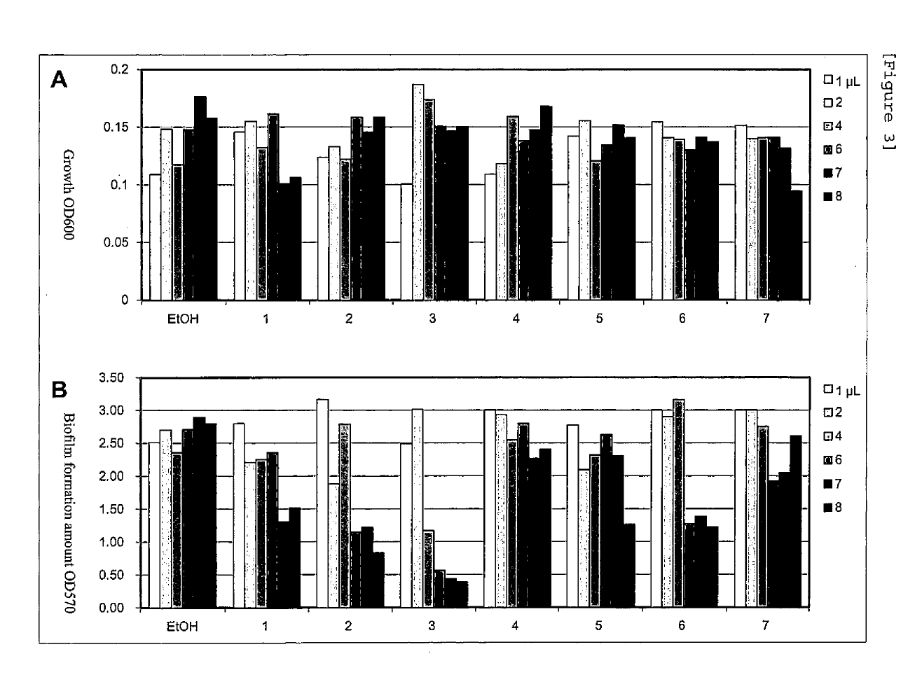

The amounts of growth (OD600) and the amounts of biofilms formed (OD570) are shown in FIG. 3; whereas growth inhibition (%) and BF inhibition (4) are shown in Table 6. In Table 6, a case where growth inhibition rate or BF inhibition rate is 0 or less is indicated by “not inhibited”. The compounds listed in Table 5 had a tendency to exhibit distinguishably higher BF inhibition rates than the microbe growth inhibition rates. The compounds listed in Table 5 showed biofilm formation inhibitory effects at a concentration where no antimicrobial effect was exhibited (a microbe growth inhibition rate: 20% or less). Accordingly, it was demonstrated that the compounds listed in Table 5 had an effect to inhibit formation of a biofilm (more specifically, non-antimicrobial biofilm formation inhibitory effect) not relying on germicidal or antimicrobial effect.

TABLE 6

| Amount of | | | | | | | | | |
|---|---|---|---|---|---|---|---|---|---|
| compound | Final | BF | Growth | Final | BF | Growth | Final | BF | Growth |
| solution | concentration | inhibition | inhibition | concentration | inhibition | inhibition | concentration | inhibition | inhibition |
| added (μL) | (ppm) | (%) | (%) | (ppm) | (%) | (%) | (ppm) | (%) | (%) |
| | 1: 4-Butylresoreinol | | | 2: 5-Methylresorcinols | | | 3: 5-Pentylresorcinol | | |
| 1 | 22 | 0.5 | — | 83 | — | — | 120 | 0.9 | 7.7 |
| 2 | 44 | 18.3 | — | 165 | — | 10.4 | 240 | — | — |
| 4 | 89 | 4.5 | — | 331 | — | — | 480 | 50.6 | — |
| 6 | 133 | 12.9 | — | 496 | 57.5 | — | 720 | 42.3 | — |
| 7 | 155 | 54.9 | 42.8 | 579 | 57.7 | 17.6 | 840 | 85.0 | 17.0 |
| 8 | 177 | 45.9 | 32.7 | 661 | 70.2 | — | 960 | 86.1 | 4.9 |
| | 4: 2-Propylresorcinol | | | 5: 2,5-Dimethylresorcinol | | | 6: Methylresorcinol | | |
| 1 | 101 | — | — | 92 | — | — | 83 | — | — |
| 2 | 203 | — | 20.5 | 184 | 0.4 | — | 165 | — | 5.2 |
| 4 | 405 | — | — | 368 | — | — | 331 | — | — |
| 6 | 608 | 7.9 | 6.8 | 552 | 10.4 | 9.3 | 496 | 53.0 | 12.3 |
| 7 | 709 | 21.7 | 16.4 | 644 | 20.4 | 14.0 | 579 | 52.2 | 20.0 |
| 8 | 810 | 14.1 | — | 736 | 55.0 | 11.1 | 661 | 56.3 | 13.3 |

| Amount of | 7: 4-Isopropylresorcinol | | |
|---|---|---|---|
| compound | Final | BF | Growth |
| solution | concentration | inhibition | inhibition |
| added (μL) | (ppm) | (%) | (%) |
| 1 | 101 | — | — |
| 2 | 203 | — | 5.7 |
| 4 | 405 | — | — |
| 6 | 608 | 29.1 | 4.8 |
| 7 | 709 | 29.3 | 19.5 |
| 8 | 810 | 21.0 | 40.2 |

—: No growth inhibition or no BF inhibition

### Test Example 4 Evaluation of Biofilm Formation Inhibitory Activity Using Aqueous System Model

Biofilm formation inhibitory activity of p-toluquinone (Tokyo Kasei) was evaluated by an aqueous system model using an annular reactor (Art Science Co., Ltd.) having a 100 mL-volume culture tank. In the culture tank of the annular reactor, a cylindrical rotating body rotating at a speed of 160 rounds per minute was installed. To the rotating body, 12 test pieces were attached in advance. These test pieces were taken out at predetermined time intervals and biofilm formed on the test pieces was quantified. From a water cooling tower provided on a building rooftop and actually used, cooling water was taken and supplied to the annular reactor culture vessel (maintained at 30° C.) at a flow rate of 10 mL per minute; at the same time, an ethanol solution (15 g/L) of p-toluquinone was separately supplied to the annular reactor culture vessel by a syringe pump YSP-201 (manufactured by YMC) at a flow rate of 10 μL per minute (p-toluquinone concentration in cooling water in the culture tank was 15 ppm). The test pieces (n=2) taken out from the culture tank at predetermined time intervals were stained with 0.1% crystal violet, thoroughly washed twice with physiological saline and recovered in ethanol (15 mL). The absorbance (OD570) was measured to obtain the amount of the biofilm formed. At the time of taking out the test pieces, water was sampled from the inlet and outlet of the reactor (n=2), smeared on R2A agar (Nippon Pharmaceutical Co., Ltd.) and cultured at 30° C. for 7 days. Thereafter, the number of bacteria cells was measured. The same experiment was carried out by using a system to which ethanol alone was added as a solvent control.

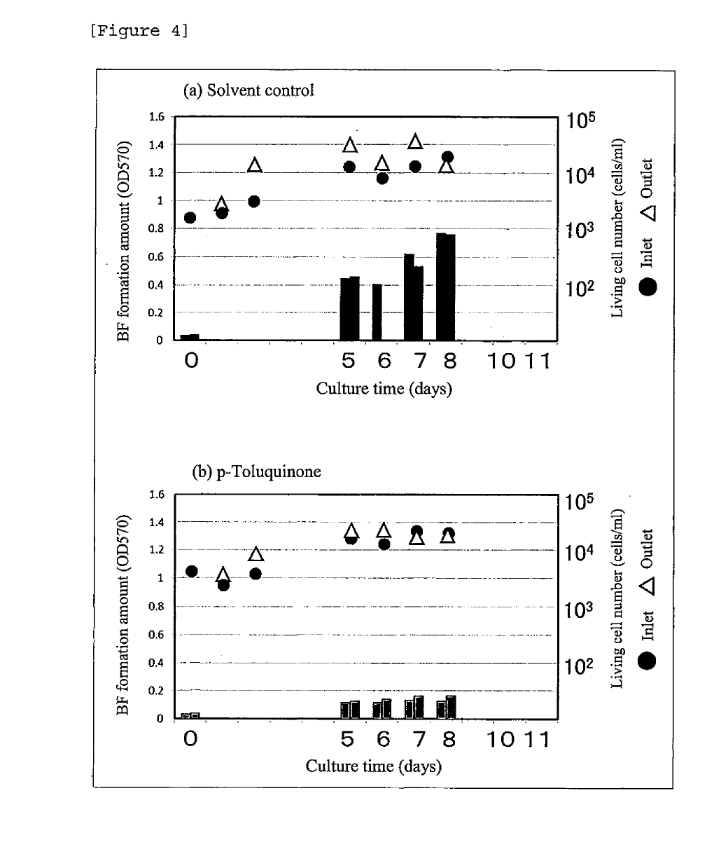

The results are shown in FIG. 4. The number of bacterial cells at the inlet or outlet of the reactor and both in solvent control system (FIG. 4 (a)) and in p-toluquinone comprising system (FIG. 4 (b)) were maintained at about 10⁴ cells/mL. From this, it was demonstrated that the number of bacterial cells was not decreased by p-toluquinone. In contrast, the amount of the biofilm formed (OD570) in the solvent control system was finally beyond 0.7; whereas the value in the case of the p-toluquinone comprising system was maintained at 0.2 or less. These results demonstrated that formation of a biofilm was inhibited by p-toluquinone without reducing the number of bacterial cells in water.

### Test Example 5 Evaluation of Biofilm Formation Inhibitory Activity Using Aqueous System Model

The number of bacterial cells and the amount of the biofilm formed were obtained in the same procedure as in Test Example 4 except that 4-butylresorcinol (Tokyo Kasei) was used in place of p-toluquinone.

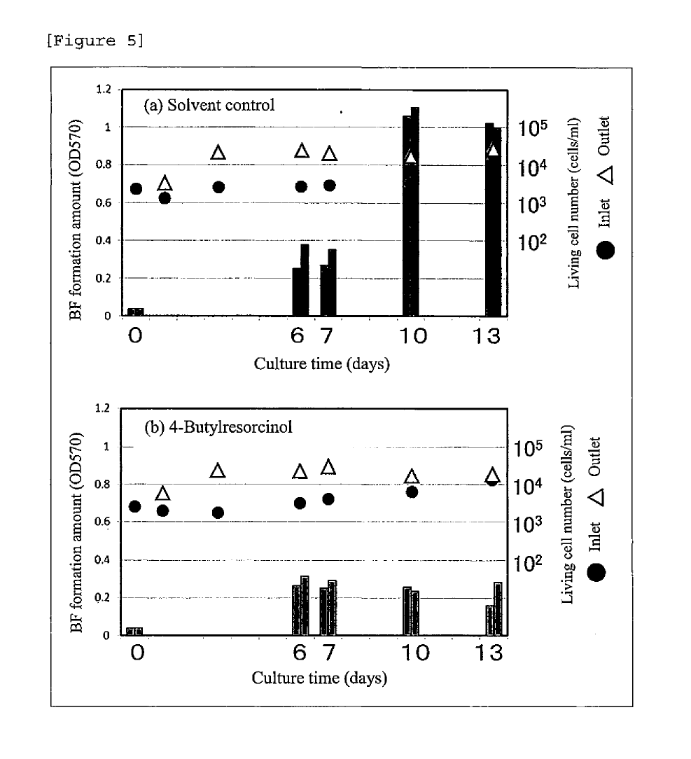

The results are shown in FIG. 5. The number of bacterial cells at the inlet or outlet of the reactor and both in solvent control system (FIG. 5 (a)) and in 4-butylresorcinol comprising system (FIG. 5 (b)) were maintained at about 10⁴ cells/mL. From this, it was demonstrated that the number of bacterial cells were not decreased by 4-butylresorcinol. In contrast, the value representing the amount of the biofilm formed (OD570) in the solvent control system was finally beyond 1.0; whereas the value in the case of the 4-butylresorcinol comprising system was suppressed at 0.4 or less. These results demonstrated that formation of a biofilm was inhibited by 4-butylresorcinol without reducing the number of bacterial cells in water.

### Test Example 6 Biofilm Formation Inhibition Composition Comprising a Quinone-Based Compound and a Chelating Agent

### 1) Reagent and Culture Medium

p-Toluquinone (Tokyo Kasei)

Chelating agent

1-Hydroxyethane-1,1-diphosphonic acid (HEDP) (Tokyo Kasei)

Citric acid (special grade, Kishida Chemical Co., Ltd.)

Ethylenediaminetetraacetic acid (EDTA) (Dojindo Laboratories)

Diethylene glycol monomethyl ether (MDG) (first grade, Wako Pure Chemical Industries Ltd.)

R2A culture medium (Wako Pure Chemical Industries Ltd.)

### 2) Biofilm Inhibition Test

### 2-1) Preparation of Test Microbe

A biofilm-forming microbe (microbe showing a OD570 value of 0.3 or more in the test for determining the amount of biofilm (the following section 2-4)) isolated from cooling water taken from a water cooling tower was cultured in R2A culture medium at 30° C. for 16 hours while shaking. The turbidity (OD600) of the resultant culture solution was measured. The culture solution was diluted with R2A culture medium to prepare a suspension of 10³ cfu/mL.

### 2-2) Preparation of Biofilm Formation Inhibition Composition

Predetermined amounts of p-toluquinone and HEDP were weighed and solvent (MDG) was added to prepare a composition. Since citric acid and EDTA were not dissolved in MDG, they were directly added in culture solutions; at the same time, p-toluquinone was directly added to the culture solutions. The formulations of individual compositions are shown in Table 7.

TABLE 7

| | | | Number | | | | | |
|---|---|---|---|---|---|---|---|---|
| | | | 1 | 2 | 3 | 4 | 5 | 6 |
| Biofilm | Quinone | p-Toluquinone | 0.2 | 0.2 | 0.2 | 0.2 | 0.2 | — |
| formation | compound | | | | | | | |
| inhibition | Chelating | 1-Hydroxyethane- | — | 0.02 | 0.1 | 0.2 | 0.4 | 0.02 |
| composition | agent | 1,1-diphosphonic | | | | | | |
| | | acid | | | | | | |
| | Solvent | Diethylene glycol | 1.8 | 1.78 | 1.7 | 1.6 | 1.4 | 0.2 |
| | | monomethyl ether | | | | | | |
| | | Water | — | — | — | — | — | 1.78 |

| | | | | | | |
|---|---|---|---|---|---|---|
| Total (g) | 2.0 | 2.0 | 2.0 | 2.0 | 2.0 | 2.0 |

### 2-3) Culture

The suspension of a test microbe prepared in the above section 2-1) was added in individual wells of a 96 well microplate in an amount of 150 μL, and then, the test solutions prepared in the above section 2-2) was each added and culture was initiated.

### 2-4) Measurement of Biofilm Amount

After the 96 well microplate was subjected to stationary culture performed at 30° C. for 48 hours, the culture solution was removed and the resultant microplate was washed with water. Subsequently, each well was stained with 0.1% crystal violet and 200 μL of ethanol was added. The absorbance (OD570) was measured to obtain the amount of biofilm (BF) formed.

### 2-5) Results and Consideration

The results of the BP inhibition test are shown in Tables 8 to 10. When Experiment No. 2 is compared to Experiment Nos. 5 to 8, it was found that the BF inhibitory effect of combined use of HEDP and p-toluquinone is higher than that of p-toluquinone alone. When Experiment No. 12 is compared to Experiment Nos. 15 to 18, it was found that the BF inhibitory effect of combined use of citric acid and p-toluquinone is higher than that of p-toluquinone alone. When Experiment No. 21 is compared to Experiment Nos. 24 to 26, it was found that the BF inhibitory effect of combined use of EDTA and p-toluquinone is higher than that og p-toluquinone alone. Compared to EDTA, NEDP and citric acid showed BF inhibitory effect at a lower concentration.

TABLE 8

| Experiment | | Quinone-based | | | | |
|---|---|---|---|---|---|---|
| No. | Composition | compound | | Chelating agent | | OD570 |
| 1 | | Toluquinone | 0 ppm | 1-Hydroxyethane- | 0 ppm | 0.764 |
| 2 | 1 | | 5 ppm | 1,1-diphosphonic | 0 ppm | 0.219 |
| 3 | | | 10 ppm | acid | 0 ppm | 0.063 |
| 4 | | | 20 ppm | (HEDP) | 0 ppm | 0.068 |
| 5 | 2 | | 5 ppm | | 0.5 ppm | 0.056 |
| 6 | 3 | | 5 ppm | | 2.5 ppm | 0.049 |
| 7 | 4 | | 5 ppm | | 5 ppm | 0.072 |
| 8 | 5 | | 5 ppm | | 10 ppm | 0.057 |
| 9 | 6 | | 0 ppm | | 5 ppm | 0.562 |
| 10 | | | 0 ppm | | 60 ppm | 0.52 |

TABLE 9

| Experiment | Quinone-based | | | | | | |
|---|---|---|---|---|---|---|---|
| No. | compound | | | Chelating agent | | | OD570 |
| 11 | Toluquinone | 0 | ppm | Citric acid | 0 | ppm | 0.329 |
| 12 | | 5 | ppm | | 0 | ppm | 0.236 |
| 13 | | 10 | ppm | | 0 | ppm | 0.048 |
| 14 | | 20 | ppm | | 0 | ppm | 0.051 |
| 15 | | 5 | ppm | | 0.5 | ppm | 0.057 |
| 16 | | 5 | ppm | | 2.5 | ppm | 0.054 |
| 17 | | 5 | ppm | | 5 | ppm | 0.054 |
| 18 | | 5 | ppm | | 10 | ppm | 0.053 |
| 19 | | 0 | ppm | | 10 | ppm | 0.261 |

TABLE 10

| Experiment | | | | | | | |
|---|---|---|---|---|---|---|---|
| No. | Quinone compound | | | Chelating agent | | | OD570 |
| 20 | Tuluquinone | 0 | ppm | EDTA | 0 | ppm | 0.407 |
| 21 | | 5 | ppm | | 0 | ppm | 0.358 |
| 22 | | 10 | ppm | | 0 | ppm | 0.048 |
| 23 | | 20 | ppm | | 0 | ppm | 0.051 |
| 24 | | 5 | ppm | | 2.5 | ppm | 0.151 |
| 25 | | 5 | ppm | | 5 | ppm | 0.077 |
| 26 | | 5 | ppm | | 10 | ppm | 0.078 |

### Test Example 7 Biofilm Formation Inhibition Composition Comprising a Quinone-Based Compound and a Chelating Agent

### 1) Reagent and Culture Medium

Quinone-based compound

p-Toluquinone (Tokyo Kasei)

4-Hexylresorcinol (Tokyo Kasei)

Organic solvents (numeral values within parentheses are C log P values)

Dipropylene glycol (−0.64)

Diethylene glycol (−1.47)

Diacetone alcohol (−0.34)

Diethylene glycol monomethyl ether (−1.18)

Propylene glycol (−0.78)

R2A culture medium (Wako Pure Chemical Industries Ltd.)

### 2) Preparation of Test Solution

As shown in Table 11, a quinone-based compound and an organic solvent were mixed to prepare each test solution.

TABLE 11

| | | | Amount of | |
|---|---|---|---|---|
| | | | quinone- | Amount of |
| Test | | | based | organic |
| solution | Quinone | | compound | solvent |
| No. | compound | Organic solvent | (% by mass) | (% by mass) |
| 0 | Toluquinone | Methanol/water | 1 | 9/90 |
| 1 | | Dipropylene glycol | 1 | 99 |
| 2 | | | 5 | 95 |
| 3 | | Diethylene glycol | 1 | 99 |
| 4 | | | 5 | 95 |
| 5 | | Diacetone alcohol | 1 | 99 |
| 6 | | | 10 | 90 |
| 7 | | Diethylene glycol | 1 | 99 |
| 8 | | monomethyl ether | 5 | 95 |
| 9 | | Propylene glycol | 1 | 99 |
| 10 | | | 5 | 95 |
| 11 | 4-Hexylres- | Diacetone alcohol | 20 | 80 |
| 12 | orcinol | | 10 | 90 |
| 13 | | | 5 | 95 |

### 3) Storage Stability Test

After test solutions Nos. 0 and 7 were stored in the conditions shown in Table 12, the amounts of toluquinone in the test solutions were measured by HPLC. Relative values (%) of toluquinone amounts to those of the test solutions immediately after preparation were obtained and storage stability of the test solutions was evaluated.

(HPLC analysis conditions)

Analysis equipment: Prominence UFLC

Eluent: 20% acetonitrile, 1% acetic acid solution

Column: L column ODS 4.6×150 mm, 5 m

Column temperature: 40° C.

Flow rate: 1 mL/min.

Injection volume: 5 μL

Detection: UV (254 nm)

### 4) Biofilm Inhibition Test

### 4-1) Preparation of Test Microbe

A biofilm-forming microbe (microbe providing a OD570 value of 0.3 or more in the test for determining the amount of biofilm in the following section 4-3) isolated from cooling water taken from a water cooling tower was cultured in R2A culture medium at 30° C. for 16 hours while shaking. The turbidity (OD600) of the resultant culture solution was measured. The culture solution was diluted with R2A culture medium to prepare a suspension of 10³ cfu/mL.

### (4-2. Culture)

The suspension of a test microbe prepared in the above section 4-1) was added in individual wells of a 96 well microplate in an amount of 150 μL. Thereafter, the test solution prepared in the above section 2) was add and culture was initiated.

### (4-3. Measurement of Biofilm Amount)

The 96 well microplate was subjected to stationary culture performed at 30° C. for 48 hours. The culture solution was removed and the resultant microplate was washed with water. Subsequently, each well was stained with 0.1% crystal violet and 200 μL of ethanol was added. The absorbance (OD570) was measured to obtain the amount of biofilm (BF) formed.

### (5. Results and Consideration)

The results of the storage stability test are shown in Table 12. The results of the BF inhibition test are shown in Tables 13 to 15. As shown in Table 12, the stability of a quinone-based compound was improved by storing the quinone-based compound in an organic solvent having a predetermined concentration. Whereas, as shown in Tables 13 to 15, BF formation inhibitory effect of combined use of a quinone-based compound and an organic solvent was lower than that of the quinone-based compound alone. The degree of decrease of the BF formation inhibitory effect by a quinone-based compound varies depending on the type and concentration of organic solvent used. From the results in Table 13, it was evaluated that the decrease of BF formation inhibitory effect of diethylene glycol was the lowest.

TABLE 12

| Test | Organic | | Quinone-based | Storage conditions | | |
|---|---|---|---|---|---|---|
| solution | solvent | % by | compound % | 40° C., | 40° C., | 40° C., |
| No. | or water | mass | by mass | one day | 4 days | 7 days |
| 0 | Methanol/ | 9/90 | 1 | 86% | 79% | 77% |
| | water | | | | | |
| 7 | Diethylene | 99 | 1 | 95% | 97% | 95% |
| | glycol | | | | | |
| | monomethyl | | | | | |
| | ether | | | | | |

TABLE 13

| | Test | | | | | | |
|---|---|---|---|---|---|---|---|
| Experiment | solution | Quinone-based | | | | | |
| No. | No. | compound (A) | | Organic solvent (B) | | B/A | OD570 |
| 1 | — | — | 0 ppm | — | — | — | 2.831 |
| 2 | — | Toluquinone | 10 ppm | — | — | 0 | 0.119 |
| 3 | 1 | Toluquinone | 10 ppm | Dipropylene glycol | 0.099% | 99 | 2.153 |
| 4 | 2 | | 10 ppm | | 0.019% | 19 | 0.106 |
| 5 | 3 | | 10 ppm | Diethylene glycol | 0.099% | 99 | 1.066 |
| 6 | 4 | | 10 ppm | | 0.019% | 19 | 0.076 |
| 7 | 5 | | 10 ppm | Diacetone alcohol | 0.099% | 99 | 1.258 |
| 8 | 6 | | 10 ppm | | 0.009% | 9 | 0.831 |
| 9 | 7 | | 10 ppm | Diethylene glycol | 0.099% | 99 | 2.252 |
| 10 | 8 | | 10 ppm | monomethyl ether | 0.019% | 19 | 0.899 |
| 11 | 9 | | 10 ppm | Propylene glycol | 0.099% | 99 | 2.073 |
| 12 | 10 | | 10 ppm | | 0.019% | 19 | 1.343 |

TABLE 14

| | Test | | | | | | |
|---|---|---|---|---|---|---|---|
| Experiment | solution | Quinone-based compound | | | | | |
| No. | No. | (A) | | Organic solvent (B) | | B/A | OD570 |
| 1 | — | — | 0 ppm | — | — | — | 2.831 |
| 13 | — | Toluquinone | 20 ppm | — | — | 0 | 0.083 |
| 14 | 1 | Toluquinone | 20 ppm | Dipropylene glycol | 0.198% | 99 | 0.105 |
| 15 | 2 | | 20 ppm | | 0.038% | 19 | 0.089 |
| 16 | 3 | | 20 ppm | | 0.198% | 99 | 0.079 |
| 17 | 4 | | 20 ppm | Diethylene glycol | 0.038% | 19 | 0.088 |
| 18 | 5 | | 20 ppm | | 0.198% | 99 | 0.077 |
| 19 | 6 | | 20 ppm | Diacetone alcohol | 0.018% | 9 | 0.084 |
| 20 | 7 | | 0 ppm | Diethylene glycol | 0.198% | 99 | 0.780 |
| 21 | 8 | | 20 ppm | monomethyl ether | 0.038% | 19 | 0.084 |
| 22 | 9 | | 20 ppm | | 0.198% | 99 | 0.605 |
| 23 | 10 | | 20 ppm | Propylene glycol | 0.038% | 19 | 0.533 |

TABLE 15

| | Test | | | | | | |
|---|---|---|---|---|---|---|---|
| Experiment | solution | Quinone-based compound | | | | | |
| No. | No. | (A) | | Organic solvent (B) | | B/A | OD570 |
| 24 | — | — | 0 ppm | — | — | — | 2.15 |
| 25 | — | 4-Hexylresorcinol | 10 ppm | — | — | 0 | 1.49 |
| 29 | — | | 20 ppm | | — | 0 | 0.10 |
| 26 | 11 | 4-Hexylresorcinol | 10 ppm | Diacetone alcohol | 0.004% | 4 | 1.55 |
| 27 | 12 | | 10 ppm | | 0.009% | 9 | 1.51 |
| 28 | 13 | | 10 ppm | | 0.019% | 19 | 1.64 |
| 30 | 11 | | 20 ppm | Diacetone alcohol | 0.008% | 4 | 0.14 |
| 31 | 12 | | 20 ppm | | 0.018% | 9 | 0.80 |
| 32 | 13 | | 20 ppm | | 0.038% | 19 | 1.14 |

1-14. (canceled)

15: A method for inhibiting biofilm formation, comprising adding at least one compound selected from the group consisting of a hydroquinone substituted by a hydroxyl group or an alkyl group, a p-benzoquinone substituted by a hydroxyl group or an alkyl group and a C1 to C5 alkyl resorcinol, in target water.

16: The method for inhibiting biofilm formation according to claim 15, comprising adding at least one quinone compound selected from the group consisting of the hydroquinone substituted by a hydroxyl group or an alkyl group and the p-benzoquinone substituted by a hydroxyl group or an alkyl group, in target water.

17: The method for inhibiting biofilm formation according to claim 15, wherein the hydroquinone is a compound represented by formula (I) and the p-benzoquinone is a compound represented by formula (II): 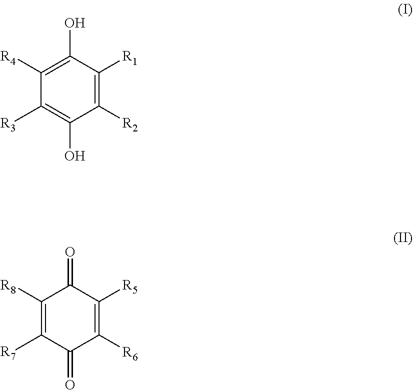
wherein R₁ and R₅ each independently represent a hydroxyl group or a linear or branched alkyl group having from 1 to 4 carbon atoms; and R₂, R₃, R₄, R₆, R₇ and R₈ each independently represent hydrogen or a methyl group.

18: The method for inhibiting biofilm formation according to claim 17, wherein, in the formula (I), R₁ represents a hydroxyl group or a linear or branched alkyl group having from 1 to 4 carbon atoms and R₂, R₃ and R₄ all represent hydrogen; or R₁ represents a methyl group, R₃ represents hydrogen and one of R₂ and R₄ represents a methyl group and the other represents hydrogen or both represent a methyl group; or R₁ represents a methyl group and R₂, R₃ and R₄ all represent a methyl group.

19: The method for inhibiting biofilm formation according to claim 17, wherein, in the formula (II), R₅ represents a linear or branched alkyl group having from 1 to 4 carbon atoms and R₆, R₇ and R₈ all represent hydrogen.

20: The method for inhibiting biofilm formation according to claim 15, wherein the compound is at least one selected from the group consisting of p-toluquinone, 2-methylhydroquinone, ethylquinol, 2-butylhydroquinone, tert-butylhydroquinone, 2,6-dimethylhydroquinone, 2,3-dimethylhydroquinone, 2,3,5-trimethylhydroquinone, tetramethylhydroquinone, hydroxyhydroquinone, 3,5-dimethylbenzoquinone and tert-butylbenzoquinone.

21: The method for inhibiting biofilm formation according to claim 16, wherein the quinone compound is added in the target water at a concentration of 270 ppm or less.

22: The method for inhibiting biofilm formation according to claim 15, comprising adding the C1 to C5 alkyl resorcinol in target water.

23: The method for inhibiting biofilm formation according to claim 15, wherein the C1 to C5 alkyl resorcinol is a compound represented by formula (III) 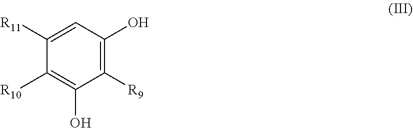
wherein R₉, R₁₀ and R₁₁ each independently represent hydrogen or a linear or branched alkyl group having from 1 to 5 carbon atom; provided that R₉, R₁₀ and R₁₁ do not simultaneously represent hydrogen.

24: The method for inhibiting biofilm formation according to claim 23, wherein any one of R₉, R₁₀ and R₁₁ represents a linear or branched alkyl group having from 1 to 5 carbon atoms and the others both represent hydrogen.

25: The method for inhibiting biofilm formation according to claim 23, wherein any two of R₉, R₁₀ and R₁₁ represent a linear alkyl group having from 1 to 5 carbon atoms and the other represents hydrogen.

26: The method for inhibiting biofilm formation according to claim 15, wherein the C1 to C5 alkyl resorcinol is at least one selected from the group consisting of 4-butylresorcinol, 5-methylresorcinol, 5-pentylresorcinol, 2-propylresorcinol, 2,5-dimethylresorcinol, 2-methylresorcinol and 4-isopropylresorcinol.

27: The method for inhibiting biofilm formation according to claim 22, wherein the C1 to C5 alkyl resorcinol is added in the target water at a concentration of 1400 ppm or less.

28: The method for inhibiting biofilm formation according to claim 15, wherein at least one compound selected from the group consisting of the hydroquinone, the p-benzoquinone and the C1 to C5 alkyl resorcinol is added in the target water at a concentration with which a growth inhibition rate of a main causative microorganism of a biofilm becomes 20% or less.

29: The method for inhibiting biofilm formation according to claim 29, wherein the biofilm is biofilm in a water cooling tower.

30. (canceled)

31: A biofilm formation inhibition composition comprising a quinone-based compound and a chelating agent.

32: The biofilm formation inhibition composition according to claim 31, wherein the quinone-based compound is at least one compound selected from the group consisting of a hydroquinone substituted by a hydroxyl group or an alkyl group, a p-benzoquinone substituted by a hydroxyl group or an alkyl group and a C1 to C5 alkyl resorcinol.

33: The biofilm formation inhibition composition according to claim 31, wherein the quinone-based compound is at least one selected from the group consisting of compounds represented by formulas (I), (II) and (IV): 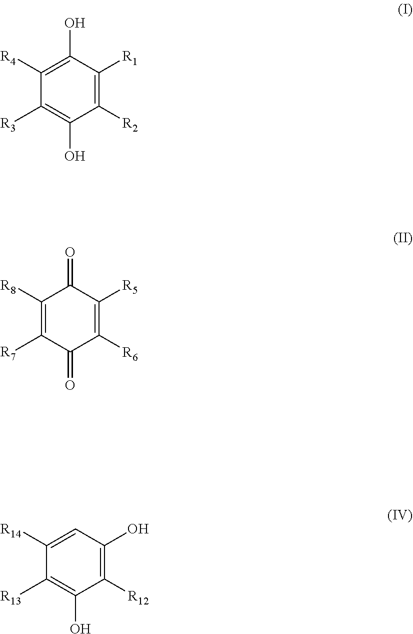
wherein
in formula (I), R₁ represents a hydroxyl group or a linear or branched alkyl group having from 1 to 4 carbon atoms; and R₂, R₃ and R₄ each independently represent hydrogen or a methyl group,
in formula (TI), R₅ represents a hydroxyl group or a linear or branched alkyl group having from 1 to 4 carbon atoms; R₆, R₇ and R₈ each independently represent hydrogen or a methyl group and
in formula (IV), R₁₂, R₁₃ and R₁₄ each independently represent hydrogen or a linear or branched alkyl group having from 1 to 8 carbon atoms; provided that R₁₂, R₁₃ and R₁₄ do not simultaneously represent hydrogen.

34: The biofilm formation inhibition composition according to claim 31, wherein the chelating agent is comprised in an amount of from 0.1 to 5000 parts by mass relative to 100 parts by mass of the quinone-based compound.

35: The biofilm formation inhibition composition according to claim 31, being a biofilm formation inhibition composition suitable for use in cooling water of a water cooling tower.

36: A biofilm formation inhibition composition comprising a quinone-based compound and an organic solvent.

37: The biofilm formation inhibition composition according to claim 36, wherein the quinone-based compound is at least one compound selected from the group consisting of a hydroquinone substituted by a hydroxyl group or an alkyl group, a p-benzoquinone substituted by a hydroxyl group or an alkyl group and a C1 to C5 alkyl resorcinol.

38: The biofilm formation inhibition composition according to claim 36, wherein the quinone-based compound is at least one selected from the group consisting of compounds represented by formulas (I), (II) and (IV): 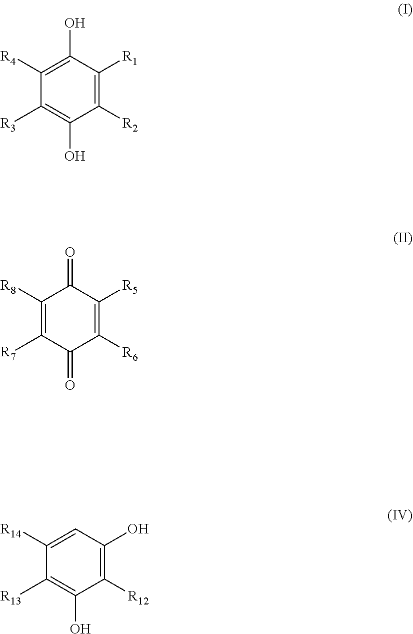
wherein
in formula (I), R₁ represents a hydroxyl group or a linear or branched alkyl group having from 1 to 4 carbon atoms and R₂, R₃ and R₄ each independently represent hydrogen or a methyl group,
in formula (II), R₅ represents a hydroxyl group or a linear or branched alkyl group having from 1 to 4 carbon atoms and R₆, R₇ and R₈ each independently represent hydrogen or a methyl group and
in formula (IV), R₁₂, R₁₃ and R₁₄ each independently represent hydrogen or a linear or branched alkyl group having from 1 to 8 carbon atoms; provided that R₁₂, R₁₃ and R₁₄ do not simultaneously represent hydrogen.

39: The biofilm formation inhibition composition according to claim 36, wherein a mass ratio of the organic solvent relative to the quinone-based compound is 500 or less.

40: The biofilm formation inhibition composition according to claim 36, being a biofilm formation inhibition composition suitable for use in cooling water of a water cooling tower.
